(19) United States
(12) Patent Application Publication
(10) Pub. No.: US 2008/0243548 A1
(43) Pub. Date: Oct. 2, 2008

(54) System for Integrated Teleconference and Improved Electronic Medical Record with Iconic Dashboard

(76) Inventor: Jason Edward Cafer, Columbia, MO (US)

Correspondence Address: Kimsey Patent Services, 804 Shamrock Avenue, Boonville, MO, 65233, US

(21) Appl. No.: 11/695,050

(22) Filed: Apr. 1, 2007

(51) Int. Cl. G06F 19/00

(52) U.S. Cl. 705/3

(57) ABSTRACT

A method for conveying complex or large amounts of data to a user in a readily understandable fashion. The method includes providing a computerized graphical user interface for displaying information to a user of the method, providing a reference database containing data pertaining to a field of endeavor engaged in by a user of the method, the reference database being stored on an electronic medium in communication with the computerized graphical user interface, streamlining by an automated process the data contained in the reference database such that at least a portion of the data is identified as being that which is pertinent to a problem being addressed by the user, displaying with the computerized graphical user interface at least a portion of the data identified as being that which is pertinent to a problem being addressed by the user, and displaying to the user with the computerized graphical user interface a graphical timeline illustrating a history of the problem being addressed by the user.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

This invention relates generally to an improved electronic medical records and teleconference system for use in the health care professions, and more specifically to an integrated teleconference and electronic medical record system with innovative multifunctional graphical icons for taking full advantage of the power of electronic media for efficient input and retrieval of medical information by health care professionals and patients.

In recent years, health care expenditures in the United States have exceeded $1.9 trillion, and the trend of increasing expenditure shows no sign of slowing. Efforts to manage health care costs have been proposed from time to time, many of which focus on the concept of efficiency. Generally, the greater the efficiency of a health care system, the lower the cost on a per patient basis.

Managed Care Organizations such as, for example, Health Maintenance Organizations (HMOs), embody one attempt to control health care costs. HMOs typically provide a set of care guidelines to the health care providers within the organization's network. A primary care physician often acts as a gatekeeper to other medical services. In theory, efficiency of medical care is increased and the costs of the overall system are lowered. In practice, however, greater efficiency is not always realized. Many attempts to increase medical efficiency are aimed at the administrative processes that make up a large portion of any health care system, rather than at the physician/patient interaction. Inefficiencies that exist at the physician/patient level are an important target area for increasing the efficiency and lower the per-patient cost of health care.

Medical records, also referred to as medical charts, are vital to the health care professions. Each medical record represents a systematic documentation of a patient's medical history and current care. Over the years, the amount and quality of patient information contained within a medical record has increased. The value of the medical record to the health care professional has undergone a corresponding increase, and because of the value of the medical record, health care professionals spend an increasing amount of time either entering information into a patient's medical record or reviewing information already contained therein. The time spent by a health care professional accessing, editing, or reviewing medical records limits the time available to the professional for other tasks, including face-to-face patient contact.

It is estimated, for example, that mental health professionals spend approximately forty percent of their time documenting patient data in a medical record, and another fifteen percent of their time retrieving data concerning individual patients from the medical record. Thus, for any given patient, a mental health professional typically spends more than one-half of the available time interacting in some way with the medical record rather than the patient. This practice tends to be repetitive and inefficient.

As the sophistication of electronic technologies has increased, such technologies have been used to address efficiencies in accessing medical records. Difficulties have remained, however, in part due to the failure to adapt traditional thinking to the modern electronic environment. Many electronic medical records systems have essentially ported the traditional medical record to an electronic environment, with little or no adaptation of the medical record to take advantage of this new environment. This had led to some increase in efficiency in terms of accessing medical records and, to some extent, navigating the information contained therein. Many of the other inefficiencies of the traditional medical record, however, remain unaddressed. In some cases, many existing electronic medical records may even be less effective than traditional paper charting. It has been estimated that at least fifty percent of physicians enter text results into an electronic record by cutting and pasting patient data from other portions of the electronic record. This leads to an increase in text volume in the record, often making the information less accurate and more difficult to retrieve than information contained within traditional paper charts. An estimate published in the Journal of the American Medical Association found that ninety percent of text in standard electronic medical records is either redundant or inaccurate (Hirschtick, JAMA 295:2335-2336, 2006). Even with respect to accurate information, accessing the desired components of an electronic medical record often requires unnecessary mouse-clicks and keystrokes, due to inefficient presentation of the record.

In addition to the above, numerous other inefficiencies exist in the current physician/patient regimen, whether mediated primarily by electronic or paper forms of record keeping. What is needed, then is a comprehensive electronic medical record that takes full advantage of the graphical power of an electronic interface, preferably in association with a teleconference system, for swift access to and utilization of medical record information at the point of physician/patient contact, and which eliminates numerous inefficiencies of both traditional paper medical records and electronic medical records.

### BRIEF SUMMARY OF THE INVENTION

The present invention provides a computerized method for conveying complex or large amounts of data to a user in a readily understandable fashion. In one embodiment of the present invention, the method includes providing a computerized graphical user interface for displaying information to a user of the method, providing a reference database containing data pertaining to a field of endeavor engaged in by a user of the method, the reference database being stored on an electronic medium in communication with the computerized graphical user interface, streamlining by an automated process the data contained in the reference database such that at least a portion of the data is identified as being that which is pertinent to a problem being addressed by the user, displaying with the computerized graphical user interface at least a portion of the data identified as being that which is pertinent to a problem being addressed by the user, and displaying to the user with the computerized graphical user interface a graphical timeline illustrating a history of the problem being addressed by the user. In one aspect of the present invention, the data and the graphical timeline are displayed concurrently.

In another aspect of the present invention, the present invention further includes the step of displaying at least a portion of the data to said the in the form of a graphical icon.

In still another aspect of the present invention, at least a portion of the information pertaining to the history of the problem being addressed by a user is provided by a client of the user in response to an electronic questionnaire answered by the client prior to the user addressing the problem being addressed by the user.

In another aspect of the present invention, the reference database is modifiable by the user.

In another aspect of the present invention, the graphical timeline includes at least one event icon representing an event being displayed along the graphical timeline.

In another aspect of the present invention, the graphical timeline includes a plurality of latitudes, each of the latitudes corresponding to a unique event to be represented along said timeline.

In still another aspect of the present invention, a plurality of users use the present method and each of said users is able to make modifications to a common reference database, the modifications made by any one of the users being visible to at least one other user of the method.

A preferred embodiment of the present invention provides a computerized method for conveying health care data to a user in a readily understandable fashion. This preferred embodiment preferably includes providing a computerized graphical user interface for displaying information to a user, providing a health care reference database, the health care reference database being stored on an electronic medium in electronic communication with the computerized graphical user interface, streamlining by an automated process the data contained in the health care reference database such that at least a portion of the data is identified as being that which is pertinent to a patient of the user, displaying with the computerized graphical user interface at least a portion of the data identified as being that which is pertinent to a patient of the user, and displaying to the user with the computerized graphical user interface a patient history graph displaying a health care history of the patient. It is preferred that the health care data and the patient history graph are displayed concurrently.

In another aspect of the present invention, the invention preferably includes the step of displaying to a user at least one medication being taken by a patient of the user, the at least one medication being displayed in the form of a graphical icon that includes graphical representation of at least one parameter relating to the patient's use of the subject medication.

In still another aspect of the present invention, at least a portion of the information displayed in the patient history graph is provided by a patient of the user in response to an electronic questionnaire answered by the patient prior to a health care session between the patient and the user.

In another aspect of the present invention, the health care reference database is modifiable by the user.

In another aspect of the present invention, the patient history graph includes at least one event icon representing an event being displayed along the patient history graph.

In another aspect of the present invention, the patient history graph includes a plurality of latitudes, each of the latitudes corresponding to a unique event to be represented along the patient history graph.

In another aspect of the present invention, a plurality of users use the present method, and each of the users is able to make modifications to a common health care reference database, the modifications made by any one of the users being visible to at least one other user of the method.

### BRIEF DESCRIPTION OF THE DRAWINGS

FIG. 1a is a diagram depicting a main screen of one embodiment of the present invention, having spaces for various functional components of the present system defined therein.

FIG. 1b is a diagram of one embodiment of customizable box 100 of the present invention upon selection of main tab 102.

FIG. 2 is a diagram of one embodiment of customizable box 100 of the present invention upon selection of interactions tab 104.

FIG.3 is a diagram of one embodiment of customizable box 100 of the present invention upon selection of patient instructions tab 106.

FIG. 4a is a diagram of a close-up view of one embodiment of medication icon area 200 having four medication icons 140 shown provided therein.

FIG. 4b is a diagram of an exemplary embodiment of a combined medication icon of the present invention.

FIG. 4c is a diagram of one embodiment of a medication icon of the present invention, the medication icon having a cursor positioned over a duration bar thereof.

FIG. 4d is a diagram of one embodiment of a medication icon of the present invention having past medication bars shown associated therewith.

FIG. 4e is a diagram of one embodiment of a medication icon of the present invention having past medication bars shown associated therewith and further having a complete past medication icon shown associated therewith.

FIG. 5 is a diagram of one embodiment of a patient history graph of the present invention.

FIG. 6a depicts an alternative representation of a line on a patient history graph of the present invention, the line shown in locked form.

FIG. 6b depicts an alternative representation of a line on a patient history graph of the present invention, the line shown in unlocked form.

### DETAILED DESCRIPTION OF THE INVENTION

The present invention provides a multi-faceted improved electronic medical record dashboard with integrated teleconference functionality and a novel iconic dashboard that takes full advantage of the graphical possibilities offered by sophisticated electronic technologies. The various innovative features of the present invention are preferably provided in a single screen, or easily accessible therefrom, utilizing graphical icons and text to provide a healthcare provider with a wealth of information at a glance. In alternative embodiments of the present invention, the various innovative features of the present invention may be spread across two or more screens, or may even be included as part of a programmable keyboard adapted to display icons or text associated with features of the present invention. Except where otherwise indicated, the description below is directed to a preferred embodiment of the present invention and is intended to be exemplary of the present invention and not to limit the present invention in any way.

Further, it should be noted that in the description that follows, the term ‘user’ is utilized to indicate a physician or other health care provider using the present system. The term ‘patient’ is used to indicate a patient receiving services from a provider utilizing the present system. While both the provider and patient are technically users of the present system, for reasons and in ways that will become clear from the description below, the term ‘user’ herein is used narrowly to indicate a provider for purposes of ease and clarity, while the term ‘patient’ is used to indicate the patient.

The physician or user interface of the present invention is a dashboard providing access to data contained in an underlying traditional electronic medical record (EMR). It is contemplated that the patient interface to the present system may be more limited and may not include all of the innovative features of the present invention. It is preferred that the underlying EMR used in conjunction with the present system is designed for compatibility with the dashboard of the present system, and is downloaded or used as a web application concurrently with the present system. The EMR, however, remains separate from the present system even though the present system may be used to modify the EMR.

It is preferred that the present system allow for bi-directional flow of information between the dashboard and the official EMR being used in conjunction with the present system. Traditional EMRs generally archive documents and data associated with a given patient record and, once saved, cannot be altered without administrative approval. The present dashboard system provides a summary of the information contained within the EMR displayed in graphical form, using icons, text, graphs, and the like. The function of the dashboard is to allow a user to enter or retrieve information as quickly as possible. One feature of the present dashboard system that serves this function is the elimination of redundant EMR data from the dashboard. Further, a user may enter or alter data contained within the present dashboard at will, without obtaining administrative approval to do so. The underlying EMR remains unchanged so that the integrity of the original EMR is not compromised. The changes or entries made by the user are saved separately from the EMR as part of the patient-specific dashboard display. For some changes to the dashboard, described more fully below, a new document or data entry may be logged in the underlying EMR, indicating that the dashboard has been changed (and preferably electronically stamped with the name of the user making the change, as well as the date and time at which the chance was made). Thus, any subsequent user accessing the EMR information via the present dashboard will be alerted to the fact that a change has been made. For all changes made to the dashboard, an itemized list of changes is archived by the present system, with each change electronically stamped with the name of the user making the change and the date and time at which the changed was made. By accessing this archive of changes, a user can undo the changes that have been made to the dashboard.

On the dashboard version of a patient chart, the representation of certain data is preferably scheduled to ‘auto-simplify’ at predetermined, defined intervals. The rate and extent of auto-simplification may be customized by a user of the present system, and defaults associated with the auto-simplification process may vary depending upon tags in the patient's chart or in the user's profile. For example—normal laboratory results are of no use to a physician once a sufficient amount of time has passed, and continued retrieval of this data into the dashboard slows the retrieval time of data that is useful to the user. The present system addresses this problem. A liver function test panel, for example, includes values for serum protein, albumin, total bilirubin, direct bilirubin, ALT, AST, and GGT. The results of these tests may be entered into the underlying EMR by and of various methods, including entry by patient, entry by a physician or user, entry by a laboratory technician or other worker in a laboratory, or in an automated fashion such as by automated digital feeds. The individual laboratory values are documented in the EMR (typically in the ‘labs’ section) and cannot be changed without administrative approval. By way of contrast, the ‘labs’ section of the present dashboard system may initially display full laboratory results, but, after three weeks for example (or after another specified time period defined by a user of the present system), normal laboratory results are displayed in a font that is smaller than that of the surrounding text, or in a color that is lighter or otherwise differs from that of the surrounding text. In some embodiments of the present system, both the font and color of the normal laboratory values may be altered. Then, after for example three month, the entire liver panel may be reduced to a summary such as ‘LFT Normal,’ or simply ‘LFT’ presented in a color, such as green, designated to indicate normal laboratory results. Further, an event icon may be plotted on the Life Timeline™ of the present system indicating normal laboratory results at a given time period. After a sufficient amount of time, as defined by user of the present system, the normal laboratory results may ‘expire’ from the dashboard entirely, no longer being represented thereon. The underlying EMR, however, remains unchanged, assuring that a user who is specifically seeking those results will still be to access them, while for all other purposes the dated normal results do not interfere with the retrieval or display of more pertinent information by the present system.

The present invention also preferably provides varying dashboard views for various users, as further described below, based upon certain user tags or preferences associated with a user's account. For example, user accounts tagged with the identifier ‘psychologist’ would see a different dashboard representation than a user tagged with the identifier ‘billing staff,’ ‘medical student,’ ‘radiologist,’ and the like. Tags may be associated with a user account based upon a user's answers to registration questions associated with establishing a user account (such as location, degree, area of specialization, and the like), or may be associated with a user account based on usage patterns, direct tagging of an account by an administrative user, or by direct or indirect choices by the user in question. Streamlining of the embedded medical reference (described below), laboratory data, patient entered data, and the like, is influenced by the tags associated with a user account such that the efficiency of data retrieval pertinent to that specific user is maximized. The present dashboard, then, excises information that is redundant or irrelevant with respect to a specific user (and the medical record is streamlined for the specific patient; for example there is no reference to ovarian cancer in the medical reference when viewed within the chart of a male patient) both automatically (for example via tags) or manually based on actions by the user. Manual changes, additions, or deletions to the dashboard representation may apply to the dashboard views seen by all subsequent authorized users of the present system, or may apply only to the dashboard representation provided to the user making the changes, depending upon the type of change as defined by the present system or upon specifications provided by individual users.

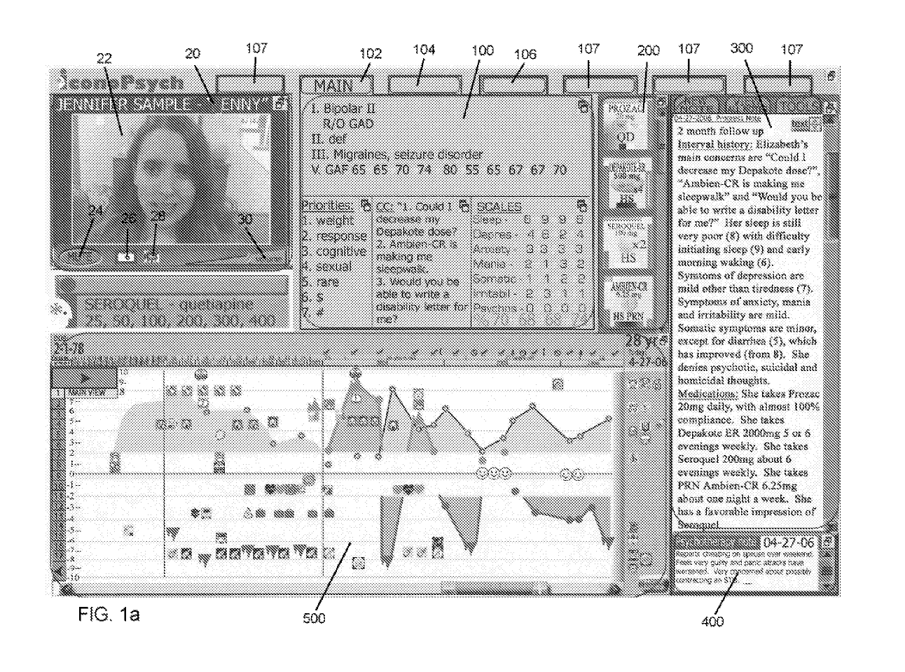

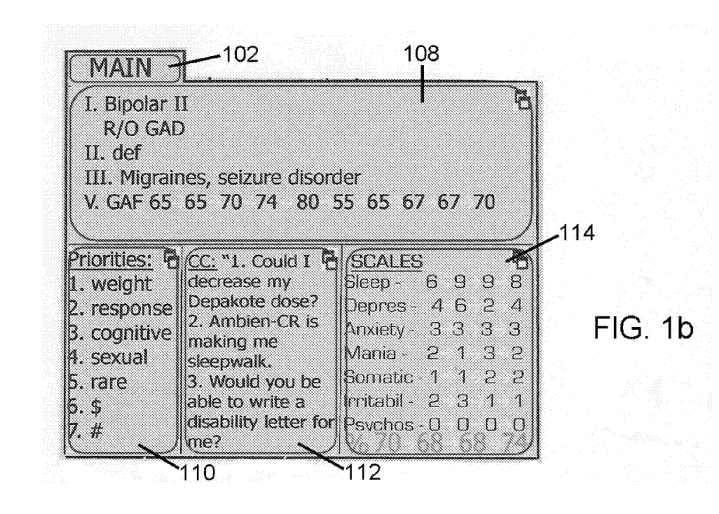

Turning now to the drawings, wherein like numerals represent like parts, numeral 10 refers generally to a preferred embodiment of a main screen of a user interface constructed in accordance with the teachings of the present invention. As shown in FIG. 1 a, main screen 10 includes various spatial ‘areas’ on the screen, including teleconference area 20, customizable box 100, medication icon area 200, progress note area 300, provider note area 400, and medical history graph area 500. Other areas may be provided as well, as described with respect to various other embodiments of the present invention, below. It is contemplated that the size, shape, and placement onscreen of the various areas described herein may be varied without departing from either the spirit or scope of the present invention. The areas presented onscreen may be customized, expanded, or contracted based upon user preference.

Before turning to a detailed description of each of the onscreen areas of the present invention, basic hardware and software information is now provided. The present invention may be implemented on any suitable computer, which may include but is not limited to a desktop personal computer, a laptop or notebook computer, a server-type computer system, or a personal digital assistant. Any suitable computer system may be used to run software developed in accordance with the present invention. Likewise, any suitable computer operating system may be used to run software developed in accordance with the teachings of the present invention. Such operating systems include, but are not limited to, any of the various versions of Microsoft Windows, MacOS, Linux distributions, and OS/2. Finally, it will be apparent to those of skill in the art upon reading this disclosure that the teachings of the present invention can be implement using any of a variety of computer programming languages. It is contemplated that any suitable language may be used and that the use of one rather than another does not depart from the spirit or scope of the present invention. Examples of programming languages that may be used include, but are not limited to, Java, C, C++, BASIC, Visual Basic, Python, COBOL, ASP, Perl, .NET, PHP, and combinations thereof.

The present invention may be implemented via a web-based software application, a stand-alone software application, or a combination of both. The various features of the present invention that require a degree of networking may utilize an established wide-area network, such as the internet, or may run entirely on a local-area network (LAN) or via dedicated network lines that, while not local, are directed exclusively toward implementation of the present invention. Any suitable network type may be used in conjunction with the present invention.

Any typical functionality associated with software programs, whether web-based or otherwise, may be incorporating into the present invention without departing from the scope of the invention. This includes but is not limited to such features as drop-down menus, checkboxes, the ability to resize and reposition windows, the ability to lock window sizes and positions, and the like.

Teleconference Area 20

As shown in FIG. 1a, teleconference area 20 is preferably generally square or rectangular in shape and is sized to provide sufficient detail to a user of the present invention without taking up so much space that the other valuable information provided by the present invention is reduced to an ineffective size. The bulk of teleconference area 20 is preferably dedicated to the teleconference image itself, with a smaller portion being dedicated to functional buttons provided to the user. Thus, as shown in FIG. 1a, within teleconference box 20 is located view screen 22, mute button 24, still shot button 26, record button 28, and slidable volume control 30.

View screen 22 displays a teleconference image transmitted by a remote camera or other recording device to the present system for display to the user thereof. The size and shape of view screen 22 may vary, though it is preferred that view screen 22 occupy as large a portion of teleconference box 20 as practical considering the desired function icons also present thereon. View screen 22 may display an image either in color or black and white, and the resolution of the image may vary depending, among other things, upon the speed of the connection between the remote camera and the present system. In a preferred embodiment of the present invention, a high-resolution color image is displayed on view screen 22. While view screen 22 is a preferred method of displaying a teleconference image associated with the present system, it is contemplated that the teleconference image may be provided on an entirely separate monitor, allowing for a larger viewing area, or may be displayed on a screen or other surface using a projector. As technology allows, the teleconferenced image may even be displayed in three-dimensional holographic form in a space near a user of the present system. Any suitable method of displaying the teleconference image may be used in conjunction with the present system.

Mute button 24 is shown in FIG. 1a located at the bottom left portion of teleconference area 20, although the location as well as the size and shape of mute button 24 may be varied without departing from the scope of the present invention. When a user clicks mute button 24, one of three conditions may be put in place: 1) mute button 24 may disable communications in both directions, such that the patient can no longer hear the physician and the physician can no longer hear the patient; 2) mute button 24 may disable communication from the patient only, such that the physician may continue to talk to the patient along a one-way communication channel; and 3) mute button 24 may disable communication from the physician only, such that the physician may continue to hear what the patient is saying, but may speak, to someone else in the room for example, without the patient hearing what is being said in return. It is contemplated that each of these three states may be achieved by repeated clicking of mute button 24 such that, for example, a single click results in condition 1), a second click results in condition 2), a third click results in condition 3), and a fourth click returns the system to its normal two-way communications state, wherein neither the physician nor the patient is unable to communicate. Alternatively, three separate mute buttons 24 may be provided, each relating to a different condition such that by clicking on one of them the physician selects the desired communication condition, and by clicking again the same mute button 24 the physician removes the condition and returns the system to its normal two-way communication state. In yet another alternative, the system may only allow one of the above conditions (disabling communications in both ways, for example), and clicking on mute button 24 simply causes the system to assume that state, whereas clicking mute button 24 a second time causes the system to return to its normal two-way communication state.

Still shot button 26 is shown in FIG. 1a as positioned just to the right of mute button 24 and having the general appearance of a camera. The size, shape, and position of still shot button 26, as well as its look and feel, may be altered without departing from the scope of the present invention, although it is preferred that still shot button 26 have the appearance of a camera or some other object that will serve to readily inform the user as to the function of the button. If during the course of a teleconference, the physician or other user of the present system wishes to capture a still-photo image of the patient, the user simply clicks on still shot button 26 and the photograph is captured. The present system preferably automatically saves the captured photograph to a predetermined location on a computer hard drive, or in some other form of computer memory. In some embodiments of the present invention, the computer file containing the stored photograph may also contain other information such as the name of the patient, the name of the physician, the date and time at which the photograph was taken, or other pertinent data identified by the user. Still photo button 26 may be used to capture a photograph at the same resolution as that of the teleconference being displayed on view screen 22, or may, in order to reduce file size, capture a photograph at a lower resolution previously selected by a user of the system. Any suitable file format may be used to save the captured image, including, but not limited to, GIF, JPEG, BMP, TIFF, and PCT.

Record button 28 is shown in FIG. 1a as being located approximately centrally and along the bottom of teleconference area 20. As shown in the figure, record button 28 has the general appearance of a motion picture camera or projector. As with the other buttons, the size, shape, and position of record button 28, as well as its look and feel, may be altered without departing from the scope of the present invention, although it is preferred that record button 28 have the appearance of a motion picture camera, projector or some other object that will serve to readily inform the user as to the function of the button. When a user of the present system clicks on record button 28, the present system begins recording, as a motion picture, both the video and audio portions of the ongoing teleconference. The system preferably automatically saves this recording onto a predetermined location on a computer hard drive, or in some other form of computer memory. The recording may be saved in any suitable format including, but not limited to, MOV, QT, AVI, MPG, SWF, and FLV. In some embodiments of the present invention, the computer file containing the stored video and audio recording may also contain other information such as the name of the patient, the name of the physician, the date and time at which the recording was made, or other pertinent data identified by the user. In an alternative embodiment of the present system, the user may be presented with an option to record audio only, thereby resulting is a smaller file size while still memorializing much of the substance of the video conference. The user may also capture a video-only recording by having properly used mute button 24, as described above, prior to initiating the recording using record button 28.

In addition to the above, teleconference area 20 may be utilized to autoplay recorded audio and/or video upon opening of a patient file by a user. When this feature of the present invention is used, specific audio and/or video clips are set to play upon opening of a patient file, and it is contemplated that the present system may also determine whether certain other parameters exist before automatically playing audio and/or video recordings, or for determining which of a plurality of audio and/or video recordings should be played. For example, when a given user opens a patient file, audio and/or video of the patient in a manic state may be played. In other circumstances, the pre-recorded audio and/or visual material may be of the patient in a depressed state, a baseline state, or a random state. At other times such as, for example, when a patient accesses her own account, pre-recorded audio and/or visual material containing user (e.g. physician or provider) instructions may be automatically played. At other times, as appropriate, a user of the present invention may open a patient file to find an audio and/or video message from a consulting physician playing automatically. The automatic playing of audio and/or video material by the present system speeds up the process of delivering information to a user or patient accessing the present system, and allows the user or patient to more readily process the information being delivered. This can be invaluable in an emergency situation or in a situation where a user has only limited time to prepare to see a patient. While this aspect of the present invention is described above as occurring within teleconference box 20, it is contemplated that the audio and/or video material may be provided in any suitable onscreen location of the present system, including a popup window, and that in situations where an audio-only message is played none of the information appearing onscreen as part of the present system need be disturbed by the playing of the audio content.

Slidable volume control 30 is shown in FIG. 1a positioned in the lower center to right portion of teleconference area 20. As shown in the figure, slidable volume control 30 has the shape of a right triangle having a minimal height at a left terminus (minimum volume) and a maximal height at a right terminus (maximum volume) of the hypotenuse thereof. Volume is increased or decreased by using a mouse to click on the volume indicator and drag it along the length of the hypotenuse to the desired volume. While this form of slidable volume control 30 is shown in FIG. 1a, any suitable form of volume control may be used, including clickable buttons that increase or decrease the volume as each button is clicked, or even a box for entry of a numerical value corresponding to the desired volume. Various methods for volume control within a software application are known in the art, and any of these, or methods developed in the future, are suitable for use with the present invention.

Customizable Box 100

To the right of teleconference area 20 in FIG. 1a is located customizable box 100. Customizable box 100 displays a great amount and variety of information to the user of the present system, and the contents of customizable box 100 change with selection of one of the various tabs positioned across the top of customizable box 100. In the embodiment of the present system shown in the drawings, these tabs include main tab 102, interactions tab 104, and patient instructions tab 106. Exemplary embodiments of each of these tabs, and the corresponding information displayed in customizable box 100, are now described.

Main tab 102 is preferably generally selected when a physician or other user begins a session using the present system, and is shown in greater detail in FIG. 1b. Main tab 102 provides the user with a great deal of information at a glance, including information regarding the patient's diagnoses, the patient's questions or concerns coming into the visit or teleconference session, and the overall mental and physical well-being of the patient. In the embodiment of the present system shown in the figures, main tab 102 provides the foregoing information in the space provided by customizable box 100, customizable box 100 being further separated into diagnosis box 108, priorities box 110, questions box 112 and scales box 114.

Diagnosis box 108 provides the user immediately with the patient diagnosis or diagnoses, as well as, if desired, other pertinent information. In the embodiment of the present system shown in FIG. 1a, for example, a global assessment of functioning (GAF) is also provided. The GAF is a numerical scale ranging from one to one hundred used to rate the functioning of adult patients. A rating of from one to ten, for example, may indicate a persistent danger of doing harm to oneself or others, while a rating of from ninety-one to one hundred may indicate superior functioning in a wide range of life activities. A rating of zero generally indicates that no sufficient basis exists upon which to make a rating. The combination of diagnoses and GAF rating provides the user with a valuable “snapshot” of the patient that takes little onscreen space, yet provides a great deal of valuable information.

Priorities box 110, shown in FIG. 1a as occupying a lower left portion of customizable box 100 when main tab 102 is selected, provides the user with a ranked list of the patient's priorities according to information acquired from the patient herself (the details as to how such information is acquired for this, as well as other portions of customizable box 100, are provided below). At a glance, therefore, the user is able to ascertain the patient's subjective priorities coming into the therapeutic session or teleconference. This provides the user with a valuable context for the session and for the patient's responses to various questions or statements throughout the session. As an alternative to a patient's ranking of priorities, the patient may simply assign a significance to each item (such as by using a numerical rating of significance from, for example, zero to ten), whereupon the present system ranks the patient's priorities according to the numerical significance assigned by the patient.

Questions box 112, shown in FIG. 1a as occupying the central lower portion of customizable box 100, provides the user with a short series of questions according to information acquired from the patient herself, such as from a pre-visit electronic questionnaire (PVEQ), which is described in more detail below. Thus, in addition to the patient's subjective priorities as set forth in priorities box 110, the physician or other user is provided with questions that are at the forefront of the patient's mind prior to the teleconferenced medical or therapeutic session. These questions can inform the dialogue between the user and patient, and also provide the user with an easy tool for making certain that the patient's primary questions are addressed during the teleconference exchange.

Scales box 114, shown in FIG. 1a as occupying the lower right portion of customizable box 100, provides the user with self-assessment information obtained from the patient prior to the teleconferenced therapeutic or other session. The self-assessment information can be related to a variety of categories depending on those deemed important by the user, and may include, for example, self-assessment related to sleeping habits or problems, depression, anxiety, mania, pain, and others. Self-assessment scales are known in the field, and any of a variety of such scales may be utilized in conjunction with the present invention, including but not limited to the Edmonton Symptom Assessment Scale, the Memorial Symptom Assessment Scale, and the Psychiatric Symptom Self-Assessment Scale (which parallels the Psychiatric Symptom Assessment Scale). The information in scales box 114 provides the user with, at a glance, a great deal of information about the state of the patient at the time the self-assessment was performed, or more precisely the patient's own perception of her state at the time the self-assessment was performed. This information can then be utilized advantageously in the teleconference therapeutic session.

It should be noted with respect to the scales described above that the use of various scales with various ranking schemes introduces an element of inefficiency into the process due to the time devoted to making sure the patient understands the ranking scheme or scale used with respect to any given self-assessment. This also introduced error into the system when, for example, a patient becomes confused as to the ranking scheme associated with a given self-assessment. It is preferred, then, that he present system apply scales, or allow customized scales defined by the user, wherein the ranking system is preserved across the various self-assessments, with a consistency of range and measurement of subjective disposition across each of the scales.

While the preceding paragraphs detail information provided when main tab 102 of customizable box 100 is selected in one embodiment of the present invention, the contents of customizable box 100 can be changed by the user by selecting another of the tabs located along the top of customizable box 100. The other tabs shown in FIG. 1a are interactions tab 104 and patient instructions tab 106.

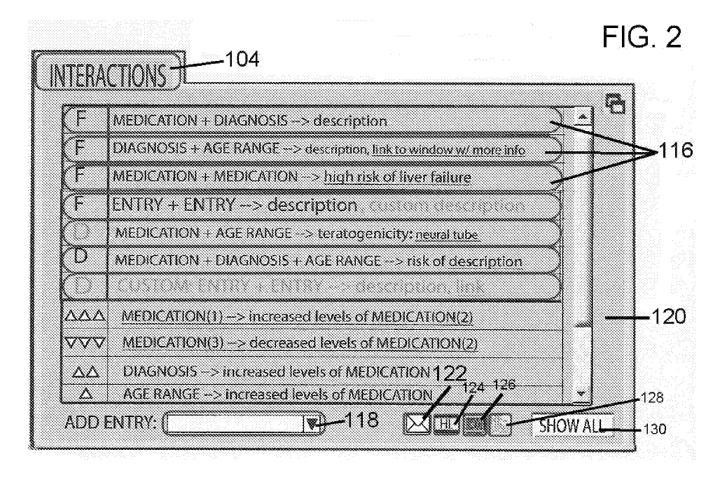

When a user clicks on interactions tab 104, customizable box 100 preferably displays information such as that shown in FIG. 2 pertaining to medication and other interactions of which the user should be aware. The central portion of customizable box 100 is occupied by interactions box 120, wherein the specific interaction information is set forth. Interactions box 120 is further divided into fields 116, each preferably containing a single line of text. Fields 116 may contain a letter or number rating of the interaction (such as, for example, the numbers A to F, with each letter corresponding to a different degree of interaction), followed by a short description of the interaction. The short description preferably sets forth the type of reaction, such as the interaction of a given medication with a certain diagnosis, the interaction of a given diagnosis and age range, the interaction between two or more medications, or any combination of the above. The short description in field 116 may further indicate a recommended course given the interaction, such as substituting an alternate medication, increasing or decreasing the dose of a medication due to interaction with other medications or due to age or other diagnoses.

The interactions and short descriptions displayed in interactions box 120 and fields 116 are preferably obtained automatically by the present system. As valuable information is entered into the system, such as diagnoses, age, gender, currently-used medications, and the like, the system accesses a database in order to determine the interactions that may be taking place and should be displayed in interactions box 120. The interaction information may be provided, in part, by a drug manufacturer, or may be provided by a third party that maintains the present system and provides access to up to date databases for the benefit of the user.

It has been shown in scientific studies that clinical outcomes improve when physicians adhere to treatment guidelines (even guidelines that have been established on less robust scientific proof than others). Many physicians do not adhere to such guidelines, however, because manually following an algorithm is time consuming and in some cases the physician may disagree with portions of the guidelines. In a preferred embodiment of the present system, therefore, a user may override the interaction information present by default in the database, substituting her own observations as to the relationship between various medications, age, diagnoses, or any number of other variables. The database is preferably modified accordingly and when interactions are present that relate to the custom-entered information provided by the user, it is this custom information that is displayed in fields 116 of interactions box 120. An exemplary embodiment for displaying drug interactions, for example, using the present invention is described more fully with respect to the medication icons of the present invention, below. This is but one aspect of the present invention that may be influenced by customizable treatment guidelines

It is preferred that the present system generate treatment guidelines (or treatment options or suggestions) via a novel automated system for Treatment Option Generation and Analysis (TOGA). The TOGA system presents treatment options based upon point values tabulated from patient specific data points, tags assigned to the patient account, and tags assigned to the user account. With respect to patient specific data points, for example, the patient may be assigned a depression rating of eight out of ten, indicating that the patient suffers from a certain degree of depression corresponding to that rating. Tags assigned to the patient account may indicate, for example, a history of bipolar disorder in the family, an allergy to penicillin, and information regarding the services or treatments covered by the patient's insurance. Tags assigned to the user's account may indicate, for example, that the user prefers to start with low levels of medication dosing and progress slowly therefrom, or that the provider has changed the overall effectiveness of the drug gabapentin for mood stabilization from the default medical reference value of “D” to a value of “A.” The TOGA system of the present invention takes this information, and any other information available, into account when generating suggested treatment plans. In the above example, whereas normally a user would not be provided with the option of gabapentin for mood stabilization due to the effectiveness rating of “D,” the user who has changed the effectiveness rating to “A” will be provided with that option for mood stabilization. Other users preferably remain unaffected by the rating change.

The TOGA aspect of the present invention, then, is a customizable physician decision support architecture with a data aggregation component. The system may include, for example, a social networking or wiki feature. A practitioner may, for example, customize spreadsheet data points from within the electronic medical record-embedded medical reference, or, using a PDA or PC, customize an online independent version of the medical reference. Rather than using traditional fully-formed algorithms for treatment options, the treatment options are tabulated, allowing for instant incorporation of new medications, new information about existing medications, genetic testing applications, and the like. The new information is provided to the medical reference by altering data points on a spreadsheet rather than by reprogramming or rewriting specific algorithms. The user who altered data points within the medical reference may enter a memo for the rest of the user community, explaining why the data point was altered. Under specified circumstances, this explanation is added to the database, for example as a ‘message board’ or wiki addition, in one or more of the following locations: within the EMR, or on a downloadable online or PDA version of the medical reference. Under specified circumstances, data point customization with attached memos generated from any of these places would appear in the database accessed by all of these places. Personal customizations of a database by a user, regardless of where made, will appear in that user's medical reference in all of the other places, including embedded in the EMR, thus affecting TOGA recommendations specific to that user. Treatment option generation involves multivariate processing of patient inputs, physician inputs, collateral inputs, and the spreadsheet “medical reference” data. Data point changes by individual physicians are pooled by a third party medical reference provider for use in subsequent versions of the database (pending approval by a moderator or other individual or group of individuals responsible for the integrity of the medical reference). The core of this component of the present invention is the integration of patient-reported problems with the pooled physician reports of relative tendency of certain medications to exacerbate or alleviate those particular problems.

In some embodiments of the present invention, the TOGA functionality of the present system may be improved, for example, by querying a user for an explanation as to why a certain option was chosen, particularly in instances where the chose option did not fall within the top three recommended options. The information provided in response to the query (with personally-identifying information preferably removed) may be provided to other users, who will be able to benefit from the rationale provided in response to the query, or may be provided to researchers seeking to better understand, for example, a physician thought process as it relates to treatment options. Any such information may be used to further refine the TOGA functionality in later iterations of the present system.

Returning to the figures, when interactions tab 104 is selected, customizable box 100 preferably further includes an add entry drop down menu 118 for adding additional items to interactions box 120. When a user selects drop down menu 118, selections from the database described above are provided. The user may then select an item from the database to include in interactions box 120. Once the item is selected, the system cross-references the selection with items already appearing in interactions box 120 and then adds the selection.

In a preferred embodiment of the present invention, when interactions tab 104 is selected customizable box 100 includes additional functionality accessed via buttons located preferably near the lower right portion of customizable box 100. As shown in FIG. 2, for example, a feedback button 122 is provided, preferably in the graphical form of an envelope or other image that renders the function of the button readily apparent to the user. When the user clicks on feedback button 122, a text box opens into which the user may type comments. These comments are then preferably transmitted to a third party who maintains the present system and the database described above. Adjacent feedback button 122 is highlight button 124, shown in FIG. 2 as having the letters “HL” included therein, although a purely graphical illustration such as a yellow bar will also suffice. When a user selected a field 116 from within interactions box 120, then clicks highlight button 124, the selected information in interactions box 120 is highlighted. Further, the highlighted status of the information is preferably saved into the database such that any time, across patient records, the same information is provided with respect to an interaction, it appears in highlighted form. It is preferred that the user can selected a highlight color from one of many available colors including, but not limited to, yellow, red, pink, blue, and green.

Customizable box 100 further preferably includes an undo button 126 when interactions tab 104 is selected. This button is shown in FIG. 2 as having the word “UNDO” provided thereon, although a suitable graphical representation may also be used. When a user clicks undo button 126, the present system reverses the last change made to the medical reference database from which the information in fields 116 of interactions box 120 is taken. Thus, if a user makes a change to the medical reference database and realizes the change was made in error, the user is able to undo the change and restore the database to its previous state. It should be noted that the medical reference database contains medical reference data only, and does not contain patient information. Thus, changes to the medical reference database do not affect the patient data in the present system. In some embodiments of the present system, multiple iterations of the undo feature may be available such that as the user reverses the most recent change to the medical reference database, a subsequent clicking of undo button 126 reverses the next most recent change to the medical reference database, and so on for a predetermined number of database changes.

Under certain circumstances, such as when a user exits the present system after making a change to the medical reference database and then re-enters the system and wishes to reverse that change, or when many changes have been made and there is sufficient error in the database that the accuracy of the database is compromised, a user may wish to the restore the database to its default state. For this purpose, the present system preferably includes a restore button 128. Restore button 128 may have the word “RESTORE” provided thereon, or may be provided in a suitable graphical form. When restore button 128 is clicked by a user, the user is preferably queried by, for example, an alert asking the user to confirm that she wishes to restore the medical reference database to its default state. Once the user confirms that the medical reference database is, in fact, to be reset to its default state, the system resets the database accordingly. As user can preferably view a log of all changes made to the database in order to better decide whether to reverse any or all of the changes made.

In a preferred embodiment of the present invention, the medical reference database is maintained by a third party for subscribers to the present system. The medical reference database is kept current by the third party maintaining the system. Changes to the medical reference database are preferably made in response to data from the primary scientific and medical literature, however it is contemplated that such changes may also be driven by users of the present system. For example, when an individual user of the present system makes a change to the medical reference database, that change is preferably passed along to the third party who maintains the database (although not automatically incorporated as a change in the default database). Based on submissions by the aggregate population of users, the third party maintaining the database can decide which changes to incorporate into the default database. Changes made by individual users may be weighted differently based upon, for example, the experience or expertise of the user who made the change. When the third party who maintains the medical reference database makes changes to the default database, these changes may automatically be reflected in the database of all users (basically functioning as an upgrade to the database), or individual users may elect to review each change individually and indicate which changes should be incorporated into their own version of the medical reference database (in some places replacing the specific changes they have already made to their database).

Another button preferably provided as part of customizable box 100 when interactions tab 104 is selected is “show all” button 130. In a default state, the present system may be configured to show in interaction box 120 only those interactions that are deemed significant (such as by designating only certain letter ranking to be visible by default, such as for example interactions labeled with either ‘D’ or ‘F’). When the user clicks on show all button 130, all interactions found by the present system in the medical reference database are shown in interaction box 120. Clicking the show all button a second time preferably returns to system to its default state, where only interactions having the desired rankings are provided.

As noted above, the present system preferably retrieves interaction information from a medical reference database provided with the present system and preferably maintained in an up-to-date status by a third party supporting the present system. In one embodiment of the present invention, the user may open the medical reference database directly, providing more specific information to the user than that displayed in interactions box 120. Since displaying excerpts from the medical reference database requires the use of screen space, it is preferred that the contents of medical history graphing area 500 are temporarily replaced by information from the medical reference database when the user chooses to access such information. When the user chooses to close the medical reference database, the usual contents of medical history graphing area 500 are returned to the screen.

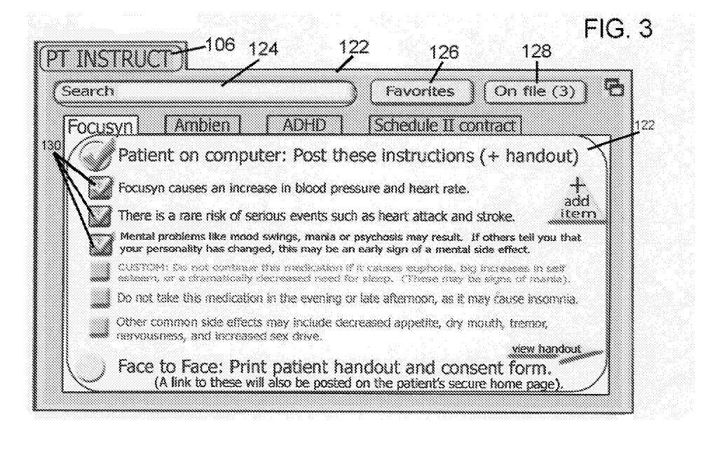

In addition to the above, the contents of customizable box 100 may be changed by selecting the patient instructions tab 106 from among the tabs located at or near the top of customizable box 100. In a preferred embodiment of the present invention, the contents of customizable box 100 after selection of patient instructions tab 106 are depicted in FIG. 3. These contents are preferably adapted to comply with informed consent laws and/or other laws and regulations such as HIPAA requirements. As shown in FIG. 3, the central and largest area of customizable box 100 when patient instructions tab 106 is selected is occupied by instructions box 122. Instructions box 122 includes an itemized list of instructions or disclosures that must be provided to the patient, and further includes a plurality of checkboxes 130 that may be selected by the user when each item of information or instruction has been provided to the patient. Checkboxes 130 may be used to indicate that a patient has received a variety of information, including information on the side effects of particular medications, interactions between two or more medications, or information regarding informed consent or the patient's privacy rights. The patient preferably clicks on each of checkboxes 130 as she reads each piece of information, thereby memorializing the fact that she has received the information. The patient may be on a computer remote from the user, such as during the preferred teleconference situation described herein, or may be physically located in the same place as the user. In either event, the provision of important information to the patient is recorded and the fact that a written version of the same instructions has been provided to the patient may also be recorded. Any handout or other form of information the user wishes to provide to a patient may be memorialized by use of instruction box 122 and checkboxes 130. In the event the patient is located in a remote area and communicating via a teleconference session, the patient preferably has the ability to access and print each individual handout or other item of information via a password-protected homepage that each patient has associated with the present system within a ‘patient portal.’

When patient instructions tab 106 is selected, customizable box 100 further preferably includes a search box 124, whereby a user can search a medical reference or other database for a given topic. Results of the search, including medical reference results, are preferably displayed as described above in medical history graph area 500. The displayed results may include information that the user of the present system should provide to a patient.

Favorites button 126 is also preferably provided in customized box 100 when patient instructions tab 106 is selected. When a user of the present system clicks favorites button 126, the present system preferably displays a menu containing the user's most often-used set of instructions. There user can therefore select instructions from this list to be provided to a specific patient.

On file button 128 provides a user with a quick method of determining which instructions have already been provided to a particular patient, the receipt of which has been memorialized by the present system as described above. Clicking on file button 128 results in this information being displayed onscreen to the user. In this manner, the present system helps prevent duplicative work in the form of repeating unnecessarily instructions to a particular patient, and also helps prevent an oversight in which a patient does not receive information that the patient should receive based on her diagnosis, prescriptions, and the like.

Medication Icon Area 200

Referring back to FIG. 1a, medication icon area 200 preferably provides a space for display of the novel medication icons of the present invention. The medication icons of the present invention provide, at a glance, a tremendous amount of information to a user of the present system, and are now described in greater detail.

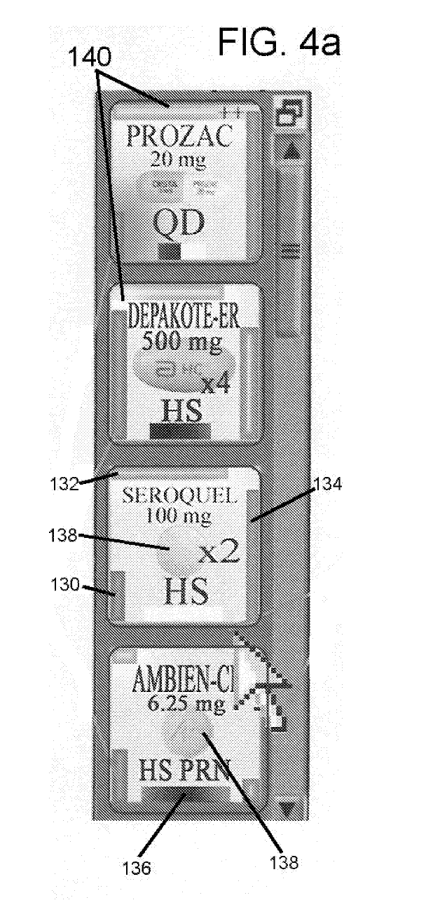

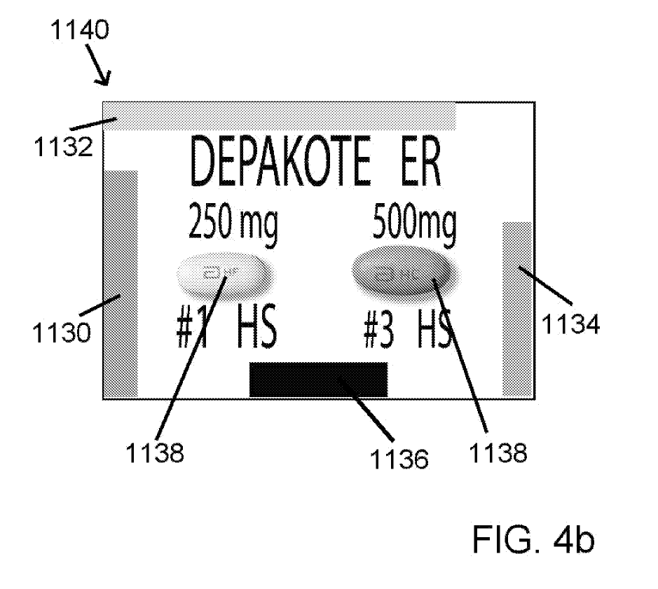

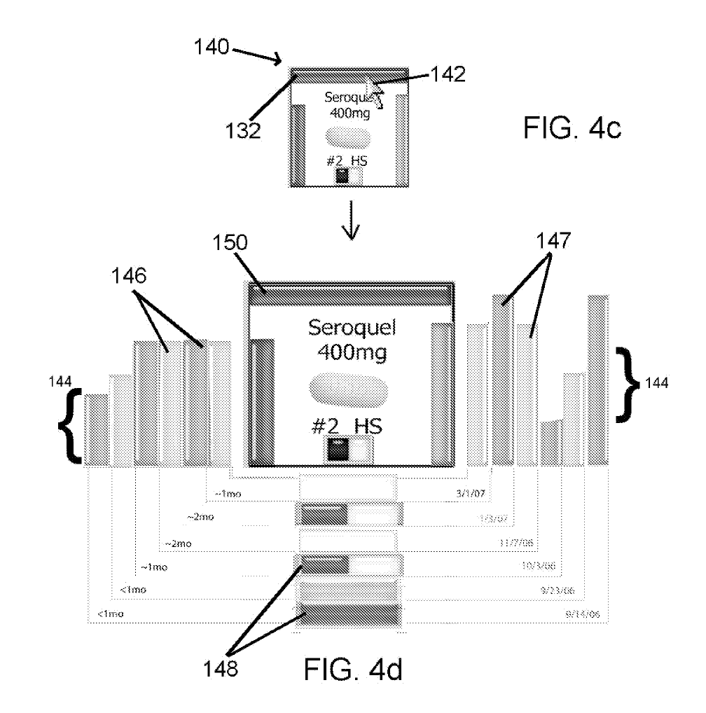

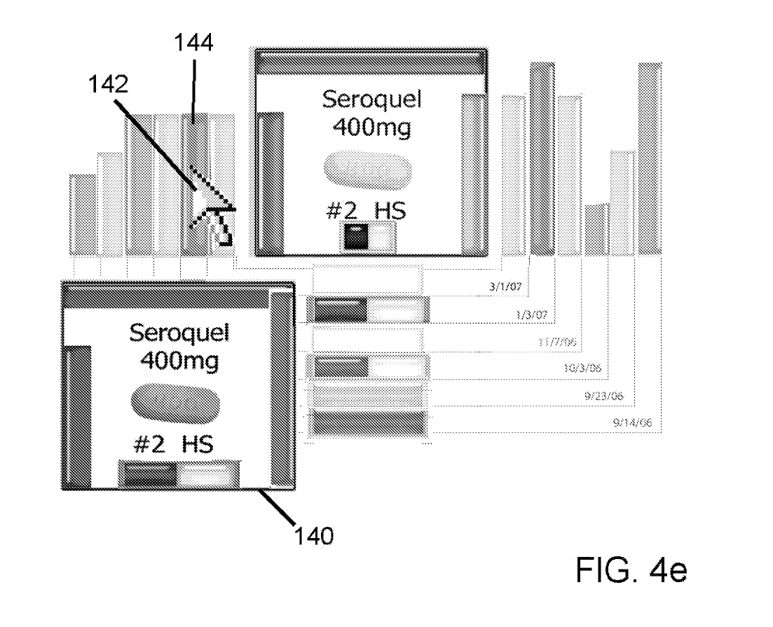

FIG. 4a provides a close-up view of medication icon area 200 having four medication icons 140 shown provided therein. Each medication icon 140 provides a wealth of information regarding the specific medication toward which the specific icon is directed, as well as regarding a specific patient in question. Each medication icon 140 preferably includes a dosage bar 130, a duration bar 132, a compliance bar 134, an impression bar 136, and a medication image 138. Medication icons 140 are preferably created automatically from information provided by a patient or other informant in response to, for example, a questionnaire. Medication icons 140 are also preferably created when a user writes an electronic prescription or medication order using the present system. The user may also choose to create a medication icon on a given patient's dashboard by selecting the medication, dosage, period of time to which the medication icon applies (e.g., current versus past medication), and other information. Once a medication icon 140 is created, a provider may drag any of the various bars associated with the icon (set forth above) to present the patient's compliance with taking the medication, duration of treatment, impression of the medication, and the like.

Dosage bar 130 is a visual representation of the dosage of a medication represented by medication icon 140 being received by a given patient. At a glance, a user can tell whether a given patient is receiving a high dosage, a low dosage, or some intermediate dosage. A greater height of dosage bar 130 indicates a greater dosage of the indicated medication being taken by the patient. Further, dosage bar 130 preferably further includes, as needed, at least one arrow or other directional image indicating whether a given patient is receiving an increased dosage of the medication represented by medication icon 140, or whether the patient is receiving a decreased dosage, due to some interaction with, for example, another medication being taken by the patient. When a medication is initially associated with a patient, the present system preferably accesses a medical reference or other database in order to obtain a usual dosage, and dosage bar 130 initially represents this usual dosage. A user of the present system is able to change the dosage by clicking on dosage bar 130 with a mouse and assigning a new dosage to the patient. Dosage bar 130 preferably incorporates additional features into the representation displayed to a user when the dosage is being modified based upon, for example, interactions with other medications. The change in dosage due to drug interactions may be represented, for example, from −3 to +3, with three triangles pointing downward indicating a −3 degree downward adjustment in dosage, and three triangles pointing upward indicating a +3 degree adjustment in dosage. The triangles are preferably located near the top of dosage bar 130 or, in some cases, overlapping at least a portion of dosage bar 130. The interaction information is initially based upon data in the medical reference database, although this information may be altered by a user of the present system. For example, the medical reference database may indicate that valproate's effect on lamotrigine levels is +2, while lamotrigine's effect on valproate levels is 0. Based on the default medical reference database, the +2 effect of lamotrigine on valproate levels will be indicated by two triangles pointing upward from dosage bar 130 of the valproate medication icon. In the event the user feels that valproate's purported effects on lamotrigine levels are a myth or are overstated, the user may change the medical reference database to reflect an effect of valproate on lamotrigine levels of +1 or 0. For this user, the medical reference database is altered accordingly.

Duration bar 132 provides a visual representation of the length of time for which a given patient has been taking the medication represented by medication icon 140. Duration of medication use is preferably proportional to the length of duration bar 132 up to one year. A duration of use greater than one year is preferably represented by placement of a single plus sign for each year as an overlay on bar 32 with the length of the bar itself reflective of a partial year of duration. For example, three and a half years of duration would be shown as three plus signs overlaying a bar half the width of the medication icon. When multiple medication icons 140 are displayed on the screen a user can determine at a glance the relative time periods over which a patient has been taking each of the various medications prescribed to that patient.

Compliance bar 134 provides a visual representation of a patient's compliance, or lack thereof, with the medication regimen prescribed. A greater height of compliance bar 134 indicates a greater level of compliance on the part of the patient. Other graphical symbols, such as, for example, arrows, can be used to indicate that while the patient generally complies, the patient sometimes takes more or less than the prescribed dosage.

Impression bar 136 provides a visual representation of a patient's subjective impression of the medication represented by medication icon 140. The length of impression bar 136 preferably remains constant, with various colors of patterns displayed therein representing the patient's subjective impression of the medication. At a glance, a user of the present system is able to determine whether a patient is generally satisfied with a medication, generally dissatisfied with the medication, or in some embodiments of the present invention the specific complaints or feelings the patient has with respect to the medication.

Preferably centrally located on medication icon 140 is medication image 138. Medication image 138 is preferably a graphical representation of a single dose of the medication represented on medication icon 140. It is preferred that medication image 138 reflect the size, shape, color, and other visual characteristics of the actual medication being represented by the icon. Thus, medication icon 140, in addition to the other functions described above, serves as a visual means of reducing confusion between various medications by a user or patient taking more than one medication.

In some embodiments of the present invention, medication icon 140 preferably further includes other useful information with respect to the medication being represented. Such information includes, but is not limited to, the amount of medication contained within each pill, capsule, or tablet (e.g. 100 mg, 500 mg, and the like), the number of pills that should be taken in order for a patient to receive a single dose, and the frequency at which a patient should be taking the medication (e.g. once per day, twice per day, and the like). A medical reference database associated with the present invention preferably includes information correlating the height of dosage bar 130 with a numerical dosage and a text descriptor. For example, a given height of dosage bar 130 for the drug Seroquel may indicate a dosage of from 50 to 150 mg per day, and an associated text descriptor of “low.” In a situation where a patient takes, for example, 25 mg of Seroquel three times per day, the present system sums the total daily dosage to 75 mg and then extends the height of dosage bar 130 to that corresponding to a low dosage. It is contemplated that any other desired information may be represented graphically or otherwise on medication icon 140, thereby providing that information to a user of the present invention, or a patient, at a glance.

Other functionality related to medication icons 140 is also provided in some embodiments of the present invention. For example, by clicking in an empty space immediately surrounding a medication icon 140, a user of the present system may be provided with a list of additional medications from which to choose for addition to the records of a specific patient. The list of medications to be chosen may be in the form of a text list, a medical reference (such as from a medical reference database), from a field of thumbnail images of various available medication icons, or from any other suitable source. When the user of the present system chooses a medication from this list, the corresponding medication icon 140 is inserted into medication icon area 200 for display therein whenever the particular patient's record is accessed. In a preferred embodiment of the present invention, when a new medication icon 140 is added to medication icon area 200, the present system automatically retrieves the correct patient instructions, which will then be displayed when patient instructions tab 106 of customizable box 100 is selected. The present system may also generate an electronic prescription which is transmitted to a pharmacy or other provider of record for pick up by the patient. Further, medication icons 140 preferably allow for a one-click change of medications by a user of the present system. By left-clicking on the name of a medication appearing in medication icon 140, a user is presented with a drop-down menu or other means of selecting from a list of medications that may be substituted for the one currently prescribed. Alternatively, the user may click through various appropriate medication icons 140 as the user left-clicks the name of the medication. In this way, changing a medication prescription is made efficient. Likewise, clicking on the text portion of medication icon 140 that provides the dosing schedule (e.g. once per day, twice per day, and the like), a user of the present system is presented with other dosing schedule options and may conveniently select from those presented.

In addition to the above, in one aspect of the present invention, a user of the present system can click and drag the various of bars of a medication icon 140 to reflect changes in patient dosing, disposition, and the like. For example, a user can click and drag compliance bar 134 from the one-hundred percent position to the ten percent position in a situation where a patient indicated during the pre-visit electronic questionnaire (PVEQ) that his compliance with a prescribed medication regimen was one-hundred percent, and then later admits during a session with the health care provider that the true compliance figure is ten percent.

In another aspect of the present invention, a user may use keyboard or mouse maneuvers, or voice commands, to change future medication instructions. For example, the user may drag dosage bar 130 from a low level to a moderate level. The present system preferably suggests the appropriate milligram dosage and/or number of pills that conforms to the new moderate level dosage selected by the user. This present system obtains this information from the medical reference database. The suggested number or type of pill (such as one ten milligram pill versus one-half of a twenty milligram pill) may vary depending on tags in the patient's chart associated with, for example, an insurance formulary, a preferred pharmacy, or a tag indicating whether or not a patient is willing to split pills in half if doing so results in a cost savings. These tags are preferably placed in the patient's chart in response to patient answers to the PVEQ.

In addition to the above, it is contemplated that in some cases combined medication icon 1140 may be used in place of medication icon 140. Combined medication icon 1140 is preferably used for common medication combinations for which it makes clinical sense to incorporate the information provided for both medications into a single icon. An exemplary embodiment of combined medication icon 1140 is provided in FIG. 4b.

As shown in FIG. 4b, combined medication icon 1140 preferably includes a dosage bar 1130 indicating the combined dosage of the two medications represented by medication icon 1140. In the example shown, dosage bar 1130 indicates a dosage level of 1750 milligrams, corresponding to 1×250 milligrams of Depakote and 3×500 milligrams of ER. The other aspects of combined medication icon 1140 function generally as described with respect to medication icon 140, above, including duration bar 1132, compliance bar 1134, impression bar 1136, medication image 1138, and the like. The height of dosage bar 130 is preferably automatically set based on a summation of the daily doses taken.

FIGS. 4c through 4e illustrate another aspect of the medication icons of the present system, which is the ability to quickly review the past medication history of a given patient via the medication icons of the present invention. FIG. 4c, for example, illustrates a typical medication icon 140 of the present invention, with a cursor 142 positioned over a duration bar 132 thereof. In this embodiment of the medication icons of the present invention, clicking on duration bar 132, without performing a dragging motion to resize the bar, results in the display of past medication bars 144 in a histogram-like arrangement alongside medication icon 140. Past or discontinued medication bars 144 are preferably provided in grayscale, whereas the various bars associated with current medications represented by medication icon 140 are provided in color.

Past medications bars 144 are shown in FIG. 4d associated with a medication icon 140. Past medication bars 144 include past dosage bars 146, past compliance bars 147, past impression bars 148, and past duration bars 150. These bars provide, at a glance, a significant amount of information concerning the medication history of a given patient. In some embodiments of the present invention, past medication bars 144 may also be associated with a textual representation of the date upon which the past medication was prescribed and/or changed. Further information regarding each of past medication bars 144 may be retrieved by placing cursor 142 over past medication bars 144, as shown in FIG. 4e, thereby causing the present system to display a complete medication icon 140 associated with the past medication bar 144 over which cursor 142 is positioned.

FIG. 4f provides further exemplary feature of one embodiment of the present invention, these features being associated with exemplary medication icons 140. In the figure, for example, dosage bar 130 of the medication icon 140 displaying information for the drug Paxil® includes a warning indicator 154 in the form of a black star (any suitable graphical or textual representation may be used for a warning indicator 154). A warning indicator 154 in dosage bar 130 of a medication icon 140 preferably indicates an interaction or contraindication relating to, for example, another medication being taken by a patient, or a diagnosis or physical condition of the patient. Warning indicator 154 serves to indicate to a user that there is an important interaction or contraindication associated with the use of the drug represented by medication icon 140, but that this interaction or contraindication does not result in an altered dosage of the drug. In a circumstance wherein a change of dosage is necessitate due to an interaction or other indication, an adjustment indicator 153 may be displayed above dosage bar 130, such as that shown in FIG. 4f as associated with the medication icon 140 for Haldol®. In the situation depicted in FIG. 4f, the fact that a patient is taking Paxil® results in an increased dosage of Haldol®, as indicated by the two adjustment indicators 153 in the form of upwardly-pointing triangles. In a situation wherein a decreased drug dosage is required due to a drug interaction or other indication, adjustment indicator 153 preferably takes the form of a downward-pointing triangle located on dosage bar 130. Although the triangular form of adjustment indicator 153 is preferred, any suitable graphical or textual representation may be used.

Medication icons 140 in FIG. 4f further include year indicators 152, provided in the form of ‘plus’ signs or crosses associated with duration bar 132. In a preferred embodiment of the invention, year indicators 152 indicate a duration of one year during which a patient was taking the medication represented by the icon. Each subsequent appearance of a year indicator 152 on a medication icon 140 indicates an additional year of duration. As can be seen in the figure, a warning indicator 154 may also be present associated with duration bar 132. Such a warning indicator located on dosage bar 132 may indicate to a user that an important situation exists with respect to the medication represented by medication icon 140 and the patient at issue. For example, warning indicator 154 associated with dosage bar 132 may indicated that a patient has been taking a medication for too long, at that the time has come for a change in the patient's dosage. Likewise, in situations where one medication prescribed to a patient is being replaced by another, such as for example by cross-titration, warning indicator 154 may indicate that it is time to further reduce the dose according to the cross-titration scheme, or that the medication at issue may now be eliminated entirely.

Also shown in FIG. 4f, a user of the present invention is preferably able to display onscreen a box or other area containing additional information regarding the information displayed on a medication icon 140. This additional area may be further subdivided into areas containing the desired information, including, for example, an interactions area 156, warning areas 158, and Treatment Option General and Analysis (TOGA) area 160. Interactions area 156 preferably contains information concerning interactions between two or more medications being taken by a patient, or other indications or contraindications due to diagnoses, physical conditions, and the like. In FIG. 4f, for example, interactions area 156 contains information that elaborates on the adjustment indicators 153 associated with dosage bar 130 of the medication icon 140 associate with the drug Haldol®. Interactions area 156 provides information indicating that a thirty to forty milligram dose of Paxil prescribed for a patient taking Haldol® results in a recommended increase in the Haldol® dosage. The recommended increase is indicated by two adjustment indicators 153, each of which may represent a predetermined dosage increase selected by a user or taken from the embedded medical reference, with two adjustment indicators meaning that the dosage adjustment is greater than that which would be represented by a single adjustment indicator 153, and less than would be represented by three or more adjustment indicators 153.

Also present onscreen in FIG. 4f are warning areas 158, each of which contains information elaborating on warning indicators 154 associated with medication icons 140. For example, a prescription of Paxil® in conjunction with a pregnancy (indicated by an event icon such as those associated with the patient history graph, described below), results in a warning. Likewise, a prescription of Haldol® in an amount of five milligrams or more, for a period greater than six months, results in a warning. In the warning area 158 associated with Haldol®, a TOGA recommendation is generated (i.e. stop Haldol®). A TOGA area 160 is also provided, TOGA area 160 containing various TOGA recommendations applicable to the situation at hand, each with a numerical values corresponding to the desirability of each recommendation in relation to the patient at issue.

In each of the areas described above wherein the present system provides additional information related to that displayed in medication icons 140, the user is provided with an option of retrieving even further details (from, for example, the embedded medical reference or wiki feature associated with the present system), or with the option of changing the information provided. Thus, if a user of the present system does not believe that Paxil® presents a problem for a pregnant patient, or a patient planning to become pregnant, the user may eliminate this contraindication from the system. For that user, this warning will no longer be provided. The user will preferably be prompted to provide an explanation for the removal of this warning so that the explanation may be incorporated into the wiki feature for the present invention for review by other users thereof. Likewise, a user of the present invention is able to change dosage adjustments recommended by the system, as well as TOGA recommendations, or the numerical ranking thereof. With any of these adjustments, the user will again preferably be prompted to provide an explanation to be incorporated into the wiki feature of the present system for review by other users. The user making the change may choose to be identified in the wiki as the person making the change, or may choose to remain anonymous. In addition, other users may rank the change and associated text, indicating agreement or disagreement with the modification. The ranking my be numerical, such as on a scale of from one to ten, or may be in the form of an alphabetic representation such as A, B, C, D, F, and the like. Any suitable ranking system may be used. In another embodiment of the present invention, the system may also provide a ranking associated with the comments of each user contributing to the wiki feature of the present invention, the ranking determined by a formula that may include such variables as the user's education, board certifications, years in practice, non-public ratings by patients, non-public rating by other users of the present system, and the like.

As shown, for example, in FIG. 4f, the various TOGA recommendations each include a numerical ranking indicating the applicability of the recommendation to the circumstances at hand. The numerical ranking or score is preferably calculated form various tags within a patient's chart. For each of various conditions indicated in the patient's chart, the relevant TOGA score may be adjusted, for example, by +2, +3, −1, −4, and the like. A user of the present system is able to view the TOGA scores for various treatment options, as well as the relevant items in the patient's chart and associated TOGA score adjustments. For example, a +4 to a given TOGA may be provided to a user, along with the textual description “Risk of Tardive Dyskinesia” to inform the user of the reason for the TOGA score adjustment. This particular +4 TOGA score adjustment may be present when a patient has been on 5 mg or more of Haldol® for six months or longer. Any relevant item in a patient's chart may have an associated TOGA score adjustment or, in fact, multiple TOGA score adjustments depending upon the treatment path being considered by a user of the present system. In a preferred embodiment of the present invention, a user may change any of the TOGA score adjustments present in a patient chart based on the user's own experience or knowledge. These changes will be saved such that it is associated with the same criteria in other patient charts when those charts are utilized by the user who made the changes. A user may change a TOGA score to zero in order to remove it from the displayed list of treatment options. It is preferred that only those options having a positive TOGA score will be displayed. Further, the user's change to a TOGA score or adjustment may be provided to the larger community of users of the present invention, along with the user's comments and ranking based on experience, education, board certifications, and the like as described above. Users also preferably have the ability to view default TOGA scores and restore the system to default values if desired, or to download updated default values and replace scores in the system with the updated values.

Further information regarding methods of tabulating TOGA scores is now provided. It is contemplated that one of skill in the art will be able to modify or supplement the TOGA calculation methods set forth herein upon reading this disclosure. The methods of calculating TOGA described in this paper are exemplary, with the TOGA system itself providing a novel aspect of the present system. Any suitable method of calculating TOGA scores is considered to fall within the spirit and scope of the present invention.

In one embodiment of the present invention, TOGA scores are calculated, for example, in the following manner. For any given medication, or dose range of medication (corrected for interactions), a list of possible side effects is provided to a user of the present system. Such side effects may include, for example, aggregate serious risks, concerns for elderly patients, concerns for early pregnancy, concerns for late pregnancy, diarrhea, constipation, hair loss, hypokalemia, and the like. Any applicable side effect may be included, though preferably side effects not pertinent to the patient at issue will not be displayed (i.e. side effects relating to pregnancy concerns are preferably not displayed in relation to a male patient). Each side effect includes a numerical ranking from, for example, zero to ten, with ten indicating the most serious level of adverse consequence and zero indicating that the side effect is not applicable. A user may change any of these values and leave comments explaining the changes made. The change in ranking will be reflected in the user's database, and may be provided, along with comments and a ranking of the change, to a broader community of users via, for example, a wiki feature of the present invention (as described above). The rankings for various side effects can then be used by the present system to make adjustments to a TOGA score associated with a given treatment option (also as described more fully above).

The TOGA feature of the present system preferably further includes additional functionality. For example, when a user selects a treatment option starting medication Y, the present system preferably updates the available TOGA options provided to the user to reflect the fact that treatment with medication Y has commenced.

Returning to the drawings, FIG. 4g depicts medication icons 140 incorporating one embodiment of a scheme for impression bars 136 associated with the present invention. Impression bars 136 utilize a simple black and white, length of rectangle scheme to communicate a patient's impression of a medication to a user of the present system. In order to more clearly point out each individual graphical scheme used with respect to the various impression bars 136, each impression bar 136 representing a different level of satisfaction on the part of a patient is provided with a separate element number. Impression bar 162, for example, represents a state in which a patient finds the medication indicated by medication icon 140 to be ‘very favorable.’ Impression bar 164, on the other hand, indicates only a ‘favorable’ impression of the medication associated with medication icon 140. Impression bar 166 indicates a ‘neutral’ impression of a medication, whereas impression bar 168 indicates that the patient finds the medication associated with medication icon 140 to be effective, but finds side effects to be problematic. Impression bar 170 indicates an ‘unfavorable’ impression, while impression bar 172 indicates a ‘very unfavorable’ impression. The scheme incorporated in the impression bars of FIG. 4g is exemplary only. Any suitable graphical and/or textual scheme may be utilized.

Given any of the various embodiment of medication icon 140 described herein, it is preferred that a text box be provided onscreen (in the form of a popup, for example) when a mouse cursor is placed over a given portion of the medication icon. For example, when a mouse cursor is placed over impression bar 136, a text box pops up preferably providing additional information about a patient's impression of a medication. Likewise, a mouse cursor placed over the dosage, duration, or compliance bars preferably provides further information concerning those aspects of the patient at issue. Placing a cursor over the image of the medication or, alternatively, the name of the medication, may provide a pop-up box containing various available dosages, or out-of-pocket cost for that medication on the part of a given patient (taking into account health insurance co-pay, lack of insurance, and the like). Further, placing a mouse cursor over a specific portion of medication icon 140 pertaining to, for example, dosage, dose schedules, and the like, preferably allow a user to change those variables from that computer screen, without having to navigate elsewhere into the program. It is preferred that a user may even change the prescribed medication by clicking on a medication icon 140 itself.

Progress Note Area 300

As shown in FIG. 1a, progress note area 300 is preferably located along the right-hand side of the screen and provides an area for the display of various notes, reports, and the like, including progress notes, initial evaluations, consults, laboratory reports, imaging reports, and the like. The information contained in progress notes area 300 is that information typically thought of as the official medical record, the information being provided in the form of an electronic medical record available for review by a user or the present system and/or the patient.

A distinction should be drawn between an official note, which is the traditional note associated with an electronic or paper medical record, and the efficient dashboard notes of the present invention. An official note is typically presented in narrative form and may, for example, contain information relating to the history of a patient's present illness, past psychiatric history, past medical history, personal history, family history, mental status exam, and the like. Because the information is presented in narrative form, review of the information by a physician takes much longer than necessary for the purpose of gleaning essential information contained therein. A dashboard note of the present invention is a shorthand version of the official note. A dashboard note preferably includes only that information a user would desire or need to see upon review of the note. Other information is not included in the dashboard note, but may be reviewed upon accessing the full official note from the present system.

When a user of the present system first reviews a dashboard note, the dashboard note is preferably pre-populated with data obtained from a patient's PVEQ, as well as information from collateral sources such as family members, referring providers, laboratory reports, x-ray reports, and the like. The dashboard note may also include sliding bars, click boxes, symbols, visual aids, widgets, or other functionality designed to facilitate the rapid retrieval and reading of information or the rapid input of patient-specific data. Items of important that are efficiently represented elsewhere in the system may also be excluded from the dashboard note, with the understanding that these items remain in the official note and may be accessed in full by a user of the present system upon accessing the official note. In a preferred embodiment of the present invention, the dashboard and official note are both electronically signed and saved by the user at the same time. When the dashboard and official notes are signed, some items contained within the dashboard note may auto-simplify or expire as described above.

The dashboard note serves separate but related purposes prior to signing by a user and after signing by a user. Prior to signing by a user, the purpose of the dashboard note is to convey to a user in a quick and efficient manner all of the information necessary to make the appropriate diagnosis and/or treatment decisions with respect to a patient. After signing by a user, the purpose of the dashboard note is to convey to a user in the future information about a specific ‘encounter’ (which may include an office visit, teleconference session, phone call, patient input by PVEQ or PDA symptom-tracking, information written by a physician after the conclusion of a patient visit, and the like).

A user of the present system is preferably able to edit either of the dashboard or official notes. Changes made to the dashboard note are preferably archived automatically in the official note. Depending on the preferences of a given user, changes to the official note may or may not be automatically reflected in the dashboard note. For example, information entered into the official note that will be of value to a user in the future may also be reflected in the dashboard note. Information entered into the official note that will not be of value to a user in the future, such as negative findings or notes pertaining to medicolegal issues, may not be reflected in the dashboard note.

Both the dashboard note and the official note are composed automatically from, for example, patient answers to a PVEQ as well as from other sources apart from the user who will sign the note. Once the official note has been ‘signed’ by a user, it may not be changed. A dashboard note, on the other hand, may be changed by the user who authored to note, or by any other authorized user. Information in the dashboard note may also be modified or removed due to auto-simplification or expiration.

Although any suitable method by which a user may post information to a patient chart or account, one preferred embodiment is now described. In this preferred embodiment, when a user signs a note entered into the present system, anything present below a red bar, present on both the official and dashboard versions of the note, is archived to the patient's account. A user may, for example, place a patient's treatment plan below the red bar so that it is properly archived. While in the dashboard view, the treatment plan may simply state, for example, “Start Prozac; 20 mg,” the text having been placed when the user of the present system selected a given treatment option. Corresponding text in the official note preferably contains a great deal more information, such as the TOGA rationale behind the choice of treatments. Detailed information in the official note may be valuable to a user in the event of a malpractice suit, because the information archived in the patient file contains specific reasons behind the selection of a given treatment option; reasons that may be used to provide a defense should such use of the information becomes necessary. Such features of the present system allow users to practice responsible, defensible medicine in an environment in which genetic, biochemical, and other information is reported at a rate far beyond a user's capability to assimilate such information. Given the embedded medical reference of the present system, which is preferably kept up to date by a third party, as well as the wiki features of the present system, a user need not even be aware of a given medical advance in order to benefit from the advance, because the advance has preferably been reflected in the embedded medical reference and/or wiki functionality of the present system.

Psychotherapy Note Area 400

As shown in FIG. 1a, psychotherapy note area 400 is preferably located in an area beneath progress note area 300 (with respect to its orientation on the screen), although any suitable placement will suffice. Psychotherapy note area 400 preferably provides a text area for psychotherapy notes, which by law are generally required to be kept separate from the rest of the medical record such that only the provider who authored a given psychotherapy note able to access the psychotherapy note, as further described below. Using the present system, psychotherapy note area 400 allows the author of a given psychotherapy note to that note, as well as other notes by that author contained within psychotherapy note area 400, while other users will see a blank field in place of psychotherapy note area 400, or will be provided instead with some other content. Based upon user or administrative settings, a user of the present system may delete all psychotherapy notes with respect to a patient authored by that user, providing an electronic equivalent of shredding sensitive information upon, for example, termination of a therapeutic relationship.

In a preferred embodiment of the present invention, the material contained within psychotherapy note area 400 is treated as a ‘psychotherapy note’ as defined by the U.S. Health Insurance Portability and Accountability Act (HIPAA). Under HIPAA, psychotherapy notes are granted special protections because of the likelihood that they contain sensitive information, and because they are considered to be the personal notes of the treating therapist. As such, these notes are not intended to be viewed by anyone other than the author. Thus, in a preferred embodiment of the present invention, information contained within psychotherapy note area 400 is available only to the user who entered the information. An alternate way of entering private data into the present system, other than by entering information into psychotherapy note area 400, is by placing an event icon in a patient history graph. A user, for example, may place an event icon on the patient history graph (described below), the icon being associated with an event suitable for a psychotherapy note. When the user places the icon, the user may also enter text to be associated with the icon. Because this text is tagged by the present system as a psychotherapy note, the event icon and text associated with it will only be viewable by the user who placed the icon and entered the text. For all other users who view the patient history graph, the icon will preferably be invisible, as will the associated text. The text is not copied into the official notes for the patient. Apart from tagging an event icon and associated text as a psychotherapy note, a user of the present system may tag an event icon and associated text as “sensitive information,” which generally described information viewable by all authorized users of the present system (i.e. those users authorized to view information for a given patient).

Medical History Graph Area 500

Medical history graph area 500 is shown in FIG. 1a as occupying a lower portion of a main screen of the present invention. This area is used to display patient history graph 502 (also referred to hereinafter as a “Life Timeline™,” which is a novel graphical representation of the medical history and/or life events of a patient.

A timeline such as the Life Timeline™ or patient history graph 502 is invaluable to a health care provider and, in particular, to a psychiatric provider. Even a relatively crude, handwritten timeline is an asset. Despite the value of such timelines, they are rarely used in, for example, the psychiatric profession, due to the amount of time required to construct the timelines. The present invention provides a timeline in the form of patient history graph 502 that requires a relatively small amount of time on behalf of the patient and, preferably, no time on the part of the provider for the initial construction of patient history graph 502. Preferably, patient history graph 502 is constructed initially entirely from a PVEQ completed by a patient. In some embodiments of the present invention, a patient may be given access to the system such that they are able to construct their own patient history graph 502 “from scratch.” It is preferred that such patient receive training on how to use the present system prior to constructing their own patient history graph 502. Construction of a patient history graph by a patient can be accomplished by, for example, dragging lines, placing event icons, typing text related to event icons directly, and the like. The patient can preferably view patient history graph as it would be seen by a user of the present system in order to ensure that information is accurately placed. Further, during the course of a teleconference visit, a user may allow placement of patient history graph 502, or any other component of the user's dashboard, on the patient's screen, either as a “view only” graphic or a corresponding dashboard that the patient may alter by some or all methods (click, drag, text entry, and the like) available to the user. These changes to the dashboard made by a patient may be saved on the dashboard if the user authorizes such a save. If electronically signed by a user, these changes to the dashboard are automatically entered into the official medical record, marked by the date of the change and the identity of the person making the change (the patient in this example).

After initial construction of patient history graph 502, patient history graph 502 is updated over time in various ways. As the patient continues to receive services, for example, subsequent PVEQs may be used to supplement the initial material in patient history graph 502. Further, data obtained via the patient's PDA and the first-on symptom tracking feature of the present invention is also incorporated into patient history graph 502. Information provided by a user of the present system, as well as by collateral sources such as, for example, friends or family of a patient who are authorized to report events relating to that patient, is also preferably incorporated into patient history graph 502.

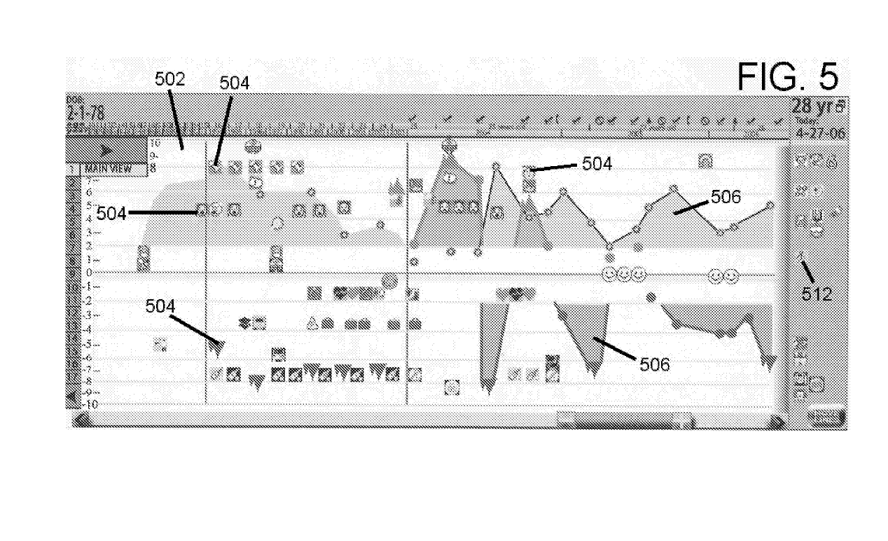

An embodiment of patient history graph 502 is shown in more detail in FIG. 5 and described now.

The embodiment of patient history graph 502 shown in FIG. 5 is preferably utilized in a psychiatric or psychotherapeutic setting, and includes not only the medical history of a given patient but a history of social and psychological events over the course of the “Life Timeline™.” Such events are represented by event icons 504. Event icons 504 are preferably easy to understand graphical representations that signify the occurrence of certain events or event types at various times over the course of the patient's life. While certain specific graphical event icons 504 are shown in the figure, it is contemplated that any suitable icon may be used to represent any given event.

It is contemplated that a user of the present system is able to move graph lines by, for example, manipulating the graph lines with a mouse or via a touch screen. The movement of graph lines on patient history graph 502 represents a dashboard alteration, and any alteration of a previously electronically signed dashboard is archived in the official medical record, or as a note or addendum to the original note where the data corresponding to that dashboard representation was documented.

Event icons 504 are preferably separated into four primary categories: 1) psychological events; 2) medical events; 3) social events; and 4) substance events. Psychological events may include, for example, periods of depression or anxiety, or periods of suicidal thoughts or behaviors. Medical events may include such events as surgeries, allergic reactions, major injuries, and the like. Social events may include schooling, marriage or divorce, arrests, physical altercations, and the like. Substance events are those events related to substance abuse, such as drug or drinking events, entering rehabilitation for drugs or alcohol, and the like. Any life events deemed important by a user of the present system may be adapted for inclusion, as an event icon 504, in patient history graph 502.

As can be seen in FIG. 5, each specific event icon 504 occupies its own horizontal plane on patient history graph 502. It is preferred that this plane remain constant, at least with respect to any given user of the present system, so that the user may quickly identify any given life event or event type by looking immediately along the appropriate horizontal plane during a session with a patient. In order to further provide information as efficiently as possible, null icons 512 are also provided, preferably along a right-hand side of patient history graph 502. Null icons 512 represent events that are not applicable to the patient whose history is being represented in patient history graph 502. Thus, a provider is immediately able to rule out certain areas of concern with respect to the patient's history, such as whether the patient has ever attempted suicide, by looking to null icons 512 for inclusion of a suicide-related icon among them. In a preferred embodiment of the present invention, adjacent patient history graph 502, is a space provided (not shown in the figures) for placement of icons relating to events that are reported to have occurred, but have not had an estimated timeframe attributed thereto. These icons, therefore, are not located on patient history graph 502. In a preferred embodiment of the invention, this space is provided to the left of patient history graph 502, and icons placed therein snap to the appropriate horizontal plane as if they had been placed on patient history graph 502.

Event icons are preferably most often placed by either a user of the present system, or by the patient to whom a given patient history graph 502 pertains. The patient places icons primarily via a PVEQ or through event reporting using, for example, the first-on PDA symptom reporting feature of the present invention. A user of the present system may place icons in various ways. In one embodiment of the present system, for example, right-clicking with a mouse or performing another action while viewing a patient history graph 502 results in the display of a menu containing event icons 504 or text descriptions corresponding to event icons 504. A user of the present system is able to drag event icons 504 from the menu to the appropriate horizontal position (representing a specific temporal position) on patient history graph 502. The vertical position to which event icon 504 is dragged is immaterial because event icon 504 preferably snaps to the appropriate vertical plane after being dragged onto patient history graph 502. Alternatively, a user of the present system may drag one or more of null icons 512 onto patient history graph 502. By so doing, the user essentially converts a null icon 512 into an event icon 504. The newly converted event icon 504 is dragged to the appropriate horizontal location on the patient history graph 502 where it is released and whereupon it snaps into the appropriate vertical plane. The specific null icon 512 that was dragged onto patient history graph 502 and converted into an event icon 504 disappears from the group of null icons 512 that are provided preferably along a right-hand side of patient history graph 502. Further alternatives for placing event icons 504 include placement using a specialized keyboard (such as, for example, the Optimus™ keyboard described below), via the use of voice recognition software, or via any other suitable means of placing and appropriate event icon 504 at an appropriate location along patient history graph 502.

In addition to event icons 504, shaded areas 506 are also preferably provided in patient history graph 502. Shaded areas 506 represent certain predetermined ongoing issues in a patient's history, and preferably also represent the severity of the issue. For example, a patient's general level of anxiety may be tracked over a given time period. This tracking over time may be represented by a line graph covering the appropriate time period. The anxiety level is represented as being higher or lower depending on the vertical height of the line. The area beneath the line is preferably shaded in order to provide an easy, efficient representation of this information to the user, who need only glance at the graphed line and shaded area to understand the time period of anxiety and the severity of the anxiety over the course of the time period. The user may preferably select whether the shading is located above or below the line, and to what latitude the shading extends.

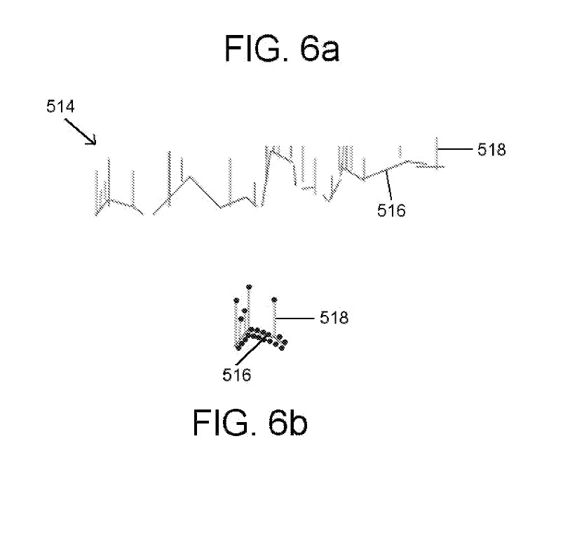

FIGS. 6a and 6b provides an alternative embodiment of a graphic line representation included in patient history graph 502. A line graph 514 such as that shown in the figure may be accessed or displayed using the present system by, for example, selecting the appropriate options or settings in the software of the present system, or by right-clicking on an existing line in the normal patient history graph 502 and choosing to display a line thereon in the manner shown in FIG. 6a. Line graph 514 provides an efficient, easy to read linear representation of desired data from patient history graph 502. In the exemplary line graph 514 shown in FIG. 6a, for example, horizontal line 516 indicates hours of nightly sleep obtained by a patient over time. Vertical lines 518 indicate hours of nap time obtained by that same patient on any given day. Thus, line graph 514 provides an efficient, easy to read representation of the sleeping habits of the patient to whom line graph 514 pertains. The embodiment of line graph 514 shown in FIG. 6a represents line graph 514 in locked form, where the data provided by line graph 514 is displayed but cannot be manipulated by a user of the present system. Alternatively, the embodiment of line graph 514 shown in FIG. 6b represents line graph 514 in unlocked form, wherein a user may click and drag the various lines 516 and 518 in order to edit the information represented by each of these lines upon, for example, obtaining new information from the patient to whom line graph 514 pertains.

Patient history graph 502 preferably spans the entire lifetime of a given patient, from birth until the date at which a provider is making use of the graph, and even extends into the future if future events such as a wedding, surgery, or other known future event is entered into patient history graph 502. The patient's date of birth is preferably provided in an upper left-hand corner of the graph. From there, patient history graph 502 extends from left to right on the screen, with spatial movement to the right representing temporal movement over the course of the patient's lifetime. Patient history graph 502 then ends at the current date, which is preferably displayed in an upper right-hand corner of the graph.

Because patient history graph 502 encompasses the entire lifetime of a given patient, it is preferred that various levels of compression exist from left to right across the chart. As shown in FIG. 5, for example, the area encompassing the first fifteen years of a patient's life may be highly compressed, such that only a small amount of horizontal space is occupied by this time period. In this compressed portion 514, major events are preferably still indicated by event icons 504, but the compression of this portion of patient history graph 502 results in the provision of less information than other less compressed portions of the graph. The age period from sixteen to twenty-five, for example, may be less compressed than that from birth to age fifteen. In the example shown in the figure, the age of sixteen may be chosen as a starting place for a less compressed graph due to the occurrence of major events around that time, events that have an impact on the current treatment and care of the patient. In this moderately compressed portion 516 of patient history graph 502, more information is provided than in compressed portion 514. More event icons 504 are included, and the lesser compression allows for more information to be imparted in the form of line graphs and the like. As shown in FIG. 5, the time period of the patient's life from age twenty-five to the present is represented in uncompressed form. Uncompressed portion 518 provides the greatest level of detail of any portion of patient history graph 502. The point at which patient history graph 502 presents information in uncompressed form may be chosen to coincide with a major life event, such as a death, that correlates with symptoms or diagnoses of that patient. Event icons 504 are more easily correlated with the timeline, in order to obtain a more accurate representation of when the represented events occurred, and line graphs and the like are able to provide an increased level of information because of the uncompressed nature of the data.

Patient history graph 502 further preferably includes a compression bar 520 located along a perimeter thereof. Using a mouse, a user of the present system may slide compression bar 520 along patient history graph 502 and alternatively compress or decompress various regions of patient history graph 502. Thus, a user of the present system may expand the level of detail for any given time period in the patient's life, while correspondingly compressing the level of detail for other time period. In this way a user of the present system is able to focus on a particular time period in a patient's life. It is preferred that when patient history graph 502 is compressed as described above, size and shape of event icons 504 remain the same. Thus, a user of the present system is able to quickly identify events occurring even over the compressed portions of patient history graph 502.

It is further preferred that patient history graph 502 is provided in layers, with a user of the present system having the ability to designate which layers are displayed at any given time. Each layer may contain, for example, event icons only, graph lines only, or a combination of event icons and graph lines. A user may specify the transparency and visibility of each line and icon independently of the layer in which the icon or graph line resides.

In addition to the above, it is contemplated a user of the present system may use a mouse, computer keyboard, or other input device to select given areas of patient history graph 502, or select the entire graph, and manipulate it such as, for example, by rotating the graph, shrinking or expanding the graph or any region thereof, or in any other way desired by the user.

Use of the Present System

As is clear from the description above, the present system provides a great deal of easy to understand information regarding a patient, in a convenient and efficient graphical form that can then be expanded upon to provide even greater information. The source of the patient-specific information provided by the present system is two-fold: 1) the patient; and 2) the user. Both a pre-visit electronic questionnaire (PVEQ) and patient self-reporting are preferably used as a source of information from the patient.

When a patient wishes to schedule an appointment with a provider or user of the present system, the patient preferably does so online, such as through a secure web site where the patient will be assigned a unique login ID and password as well as a secure web space to use for receipt of patient instructions, prescriptions, and the like. During the appointment scheduling process, the patient's biographical information, as well as billing and insurance information, is preferably obtained. In certain circumstances, the patient may be required to speak a phrase into a webcam, with an audio and video recording made and archived for later review if the identity of the patient comes into question. Alternately, retinal identity scans may be employed. Retinal identity scanning would be most useful to determine whether a previous patient, with stored retinal identity information, is attempting to create another account, for example, for the purpose of obtaining additional prescriptions for controlled substances from multiple providers, medication samples for black market sale, or for other illegitimate purposes.

Once the patient has access to the web site and is able to logon, the patient is provided with options such as scheduling or canceling an appointment, editing billing or insurance information, editing biographical information, and answering necessary PVEQs. The patient, then, preferably begins the PVEQ process at home, providing the system with details about the patient's medical, psychological, and social history by answering a series of specific questions that cover these areas. Depending on the preferences of a provider, the patient maybe allowed to choose an interview of brief, moderate, or comprehensive duration. As the patient answers these questions, the present system may prompt the patient for further details regarding any given event or issue, these details to be used in constructing patient history graph 502 prior to the patient having had a single session with a user of the present system. If the patient did not complete the PVEQ at home, or if additional information is sought, the patient may be directed to a computer on the day of the patient's appointment, in order to answer additional questions prior to meeting with a provider or user of the present system. In a preferred embodiment of the present invention, a user of the present system may be alerted to the fact that the patient is taking a PVEQ at the time the patient is answering the questions, and may therefore modify the questions in real time based on the patient's answers, requiring additional information related to some areas of the patient's history, or skipping over other areas entirely. This allows the provider to obtain to most salient information in a situation, for example, where time is limited and the patient is unable to complete the entire PVEQ. In addition to information regarding medical and personal history, the patient may also provide information regarding previous physicians or therapists seen, and medications currently or previously taken by the patient.

The present system takes the results of the PVEQ, as well as the patient's established medical record (if any), and generates the novel graphical interface and representations described with respect to the present system, above. The user of the present system, then, obtains a wealth of information prior to ever visiting with the patient. In situations where time to prepare for a session with a patient has run short, the provider is able, at a glance, to learn much about the patient's history, medication status, current feelings, and the like. Likewise, prior to any given session a provider receives up to date information based on additional PVEQs or on the results of patient self-reporting. Further, during the session a user of the present system is able to edit the information provided by the present system in order to more accurately capture the patient history, medication status, current state, and the like. The PVEQ results are represented in various places throughout the present system such as, for example, official notes, dashboard notes, visual icons, and the like.

In some embodiments of the present invention, the PVEQ is presented in the form of audio and/or visual elements provider by a user of the present system. Thus, a patient responds to the PVEQ by responding to audio questions asked by a user of the system, in some cases with corresponding video elements. In this way, a user of the present system is able to develop a rapport with a patient prior to meeting with the patient for the first time. Before the first meeting takes place, the patient has preferably become accustomed to the sound of the user's voice, and in some cases to the appearance of the user on a computer screen being used by the patient.

Patient Self-Reporting

Patient self-reporting is an important part of any treatment regimen, particularly in the mental health care professions. Patient compliance with self-reporting, however, is often less than desirable. The present system provides a novel, innovative way to increase patient compliance with self-reporting through the use of a portable electronic device such as a personal digital assistant (PDA).

When being treated by a user of the present system, and therefore ‘enrolled’ in the system via a secure personal web site, as described above, a patient preferably receives a PDA that is in communication with the present system and adapted to provide information thereto. In most ways, the PDA functions as a normal PDA, giving the patient an incentive to use the device to access the desired features contained therein. The device, however, also acts as a self-reporting mechanism, and more importantly a mandatory self-reporting mechanism that is not overly oppressive from the patient's point of view.

Any time a patient turns on a PDA associated with the present system, a first-on feature of the present system is initiated, and the PDA presents the patient with a short series of questions that must be answered prior to accessing the desired functions of the PDA. The questions may, for example, ask the patient to rate numerically her average levels of anxiety or frustration over the previous week. Once the patient answers the questions, the PDA exits the question screen immediately, allowing the patient to use the PDA. In an alternative embodiment of the present system, the patient may exit the questions displayed at startup by simply choosing the exit function, whether the questions are answered or not, however in such embodiments choosing the exit function preferably results in a delay before the patient can access the functionality of the PDA, thereby giving the patient an incentive to answer the questions because answering the questions will lead to quicker access to the PDAs other functions. Further, it is contemplated that in a preferred embodiment the PDA will enter a sleep mode if not used for a period of time, and that mandatory questions will be presented when the PDA ‘wakes up,’ from sleep mode (by being used again). Thus a patient may not avoid the self-reporting questions by simply leaving the PDA on for long periods of time.

In addition to the mandatory questions presented at start up, a PDA of the present system preferably further contains an at-will self-reporting feature, whereby a patient may at any time report an event to the present system. The system will prompt the patient to answer certain questions regarding the type of event being reported, the time of occurrence of the event, the severity of the event, or for any other information deemed pertinent to the self-reporting. The patient may also be provided with the option of taking a full symptom inventory or, alternatively, a brief symptom inventory, depending on the level or reporting desired by the patient. The present system saves the responses to such questions, thereby creating a type of health status ‘journal’ which can later be reviewed with respect to any given timeframe.

Results of the patient's self-reporting activity are assimilated by the present system for input as described above. Events reported will appear, for example, in patient history graph 502. Concerns or questions expressed by the patient via the PDA question and answer sessions (or via PVEQs) may be represented in priorities box 110 or questions box 112. Numerical representations of anxiety or frustration levels may be represented in scales box 114. Upon reviewing the information immediately prior to the next session with the patient, a user of the present system receives a detailed representation of the current mental and physical state of the patient, as well as the mental and physical state of the patient during the time interval between the last session and the current session.

In addition to the above, various additional features of the present invention are contemplated. These additional features are now described briefly.

Reciprocal Reporting

As described above, a patient is able to report events using a first-on self-reporting feature associated with a patient's PDA, or by using the at-will self-reporting feature of a PDA. In addition to this feature of the present system, as described above, some embodiments of the present invention include a reciprocal reporting feature by which a patient is able to report not only with respect to him- or herself, but with respect to other patients for whom that first patient is authorized to report. The output of this reporting is routed to the appropriate electronic medical record rather than being entered into the record of the reporting patient. A digital image of the person whose behavior or symptoms are being reported is preferably displayed on the PDA screen so that the patient making the report does not inadvertently report on the wrong person. Under certain circumstances, the person reporting behavior or symptoms pertaining to another individual may be required to verify her identity by speaking a specified word or phrase into a webcam, with voice and visual data archived for later use if the identity of the person reporting behavior or symptoms is called into question. This security provision may be used to address, for example, individuals making false collateral input for the purpose of obtaining controlled substances.

System-Defined Distribution of Text Changes

The present invention preferably provides for an accurate and efficient distribution of information throughout the system by distributing changes in text in one portion of the system to other defined areas of the system incorporating that same text. Changes in a text string in one place may result in a change of part or all of that text string in, for example, various icons, dashboard notes, official notes, and box notes. The portions of a text string that may be altered in one place by changes to that text string in another place are defined in the system settings and may be customized by a user of the present system.

Objective Automated Mental Status Exam

As described above, the present invention preferably makes use of a webcam or other camera for the purpose of providing teleconference functionality to the system. It is contemplated that the webcam, or other devices used by a patient such as a PDA, may also be used to provide direct medical information to a user of the present system. An objective automated mental status exam, for example, may be performed by the present system via the technological devices associated with the system. In one embodiment of such a system, for example, a webcam or other recording device located in the patient's PDA or in use during a teleconferenced medical or therapy session, generates a recording of the patient's speech, movement, and other characteristics during the session. The present system then analyzes the patient in terms of, among other things, amount of speech, eye contact, pupil size and reactivity, pressure of speech, voice analysis (such as, for example, to detect lies), and other characteristics. The present system may also document facial symmetry, providing numerical values to symmetry the system “observes” via video of a patient. By comparing “normal” values for facial symmetry with values obtained via video in real time, the present system can alert a user as to when a patient undergoes a change in facial symmetry (indicating, for example, that a patient may have suffered a stroke). The present system documents these characteristics for later evaluation by a practitioner. The findings of the objective automated mental status exam may be included in the official notes, the dashboard notes, the patient history graph, or any other suitable portion of the present system. A user of the present system may sign off on these automated readings, thus saving the time required to record the findings as subjective observations. Under some circumstances, the provider may delete any of the automated readings if he does not wish to archive them, as long as this is done prior to signing off on the note, and the readings will not be archived in the official note.

Specialized Dynamic Keyboard

In each of the embodiments and descriptions of the present invention provided above, it is contemplated that any suitable method of entering, editing, deleting, or otherwise manipulating the information contained within the present system may be used. This includes not only any suitable conventional means of manipulating a computer graphical user interface such as by, for example, accessing menus via a mouse or directly manipulating objects by clicking and dragging with a mouse, but also includes less conventional methods of manipulating a computer graphical user interface, such as via the use of voice commands or a specialized keyboard. One exemplary embodiment of a specialized keyboard that may be used in conjunction with the present invention is the Optimus™ keyboard. An Optimus™ keyboard includes a miniature display for each key on the keyboard, the display indicating the function of a given key at any given time. During standard usage, for example, the keys of an Optimus™ keyboard may display the typical QWERTY keyboard layout. At other times, the display on each key may be altered in such as way as to present a QWERTZ keyboard, or the keys of a Dvorak Simplified Keyboard. The function of each key, and the concurrent display on each key, is programmable by the user of the Optimus™ keyboard, or is determined by the software with which the Optimus™ keyboard is being used. It is contemplated that the present invention may be adapted for use with an Optimus™ or similar keyboard such that the various commands and functions of the present invention may be assigned to specific keys on the Optimus™ keyboard, the keys in turn displaying graphical representations that are readily associated with the corresponding command or function. When using patient history graph 502, for example, keys on the Optimus™ keyboard may display various event icons 504 that are to be included in patient history graph 502.

In a preferred embodiment of the present invention utilizing an Optimus™ or similar keyboard, the display associated with each key also presents to a user information unrelated to the function assigned to that key. In essence, the keyboard itself becomes an extension of the novel dashboard representation of the present invention. For example, at an appropriate time during the use of the present system, the keys on the keyboard may change to represent the medications most commonly prescribed by a psychiatrist. The medication representations are preferably grouped on the keyboard in a logical manner, such as for example with drugs in similar classes grouped together or present in certain specified columns or rows. The medications shown are preferably those deemed appropriate to the specific patient whose information is being displayed by the present system according to the medical reference database in either its default state or its altered state reflecting changes or preferences of a user of the present system. The display associated with each key may provide a picture of the medication linked to that key, and may also provide a short text identifier of the medication. It is contemplated that the background color of the key display provides a user with information regarding the patient's history with respect to that particular medication. For example, a first background color may be used to indicate that the patient has never used the medication at issue, whereas a second background color may indicate that the patient has taken that particular medication in the past. A third background color may be utilized to indicate that a patient is currently taking the medication associated with a particular key on the Optimus™ or similar keyboard. Predetermined keys on the keyboard (such as shift, ctrl, alt, or function keys f1 to f12, for example) may be used to vary the background colors of each key in order to provide other pertinent information to the user. After pressing one of these keys, for example, a certain background color associated with a particular medication displayed on one of the keyboard keys may indicate that the patient has a low co-pay for that medication, or that the co-pay is high, or that the patient's insurance does not cover that medication. The potential for providing information via visual displays such as on an Optimus™ or similar keyboard is great, and it is contemplated that use of such a keyboard with a system, or with an alternative electronic medical record system, is within the scope of the present invention.

Positioned Webcam for Maintaining Eye Contact During Teleconference

In another alternative embodiment of the present invention, a webcam associated with the present invention is centrally located on a computer screen used by a user of the present invention, or is located near to the view of a patient's face during a teleconferencing session. This ensures that a user of the present system will more often and more closely maintain eye contact with a patient while retrieving data from the present system or entering new data into the present system. In a situation wherein the webcam or other camera associated with the present invention is not so positioned, a patient may be unaware that a user of the present system is typing or retrieving information from the present system, and may obtain the impression that the user is not maintaining eye contact with the patient due to lack of interest or attention. Ideally, the webcam or other camera is incorporated into the computer screen or monitor itself, and an invisible component thereof, and is able to track the eye movement of a user of the present invention such that no matter where on the screen the user is looking while retrieving information from the present system or entering information into the present system, the patient receives the impression that the user is maintaining eye contact.

Problem-Based Continuing Medical Education

In a preferred embodiment of the present system, the system provides a user thereof with continuing medical education based on patient information or characteristics pertinent to the work the user performs. For example, prior to a visit or teleconference session with a patient, the present system may present questions to a user in the form of a short quiz, the questions being directed to subject matter pertaining to the diagnoses, medications, and the like of the patient the user is preparing to see. These questions may be coupled with information provided to the user in narrative form concerning the same topics. If desired, the present system may also log and verify the fact that a user has taken part in a certain quantitative or qualitative amount of continuing medical education. Ideally, the user may access this function from mobile devices, to prepare the user, during breakfast for example, for issues that will arise during the course of seeing patients that day.

Earmarking Functions

In each of the embodiments and aspects of the present system described above, the present system is preferably adapted to allow for earmarking of text, pictures, or other data within the system. Data may be earmarked for later archiving, automated language translation, automated lay-person translation, automated production of patient attachments or instructions, or for any other purpose.

Letter Composition

It is further contemplated that in a preferred embodiment of the present invention, the system includes letter composition functionality wherein a user can readily incorporate information from the system into a letter to be sent to another doctor, an insurance company, or the like. Once such letter composition functionality has been selected, or the system has been placed in a letter composition mode, it is contemplated that information displayed by the present system, such as for example the medication icons, can be dragged into a note window or other suitable location. The system recognizes that the information or graphical element of the present system has been dragged into the appropriate window or other onscreen location and automatically generates text related to the dragged information in a format suitable for inclusion into a letter. In a preferred embodiment of the invention, the generated text is then automatically incorporated into a letter being written by a user with the help of the automated features of the present invention. For example, upon dragging a medication icon into the appropriate window or other location, the present system generates text that reflects the information contained within the icon. A sample string of text that may be generated is as follows: “John is currently taking Prozac 40 mg, a moderate dose. He has been on Prozac for approximately 8 months. He is fond of this medication, and reports at least 95% compliance with taking it.” The automatic incorporation of this text into a letter makes letter writing or generation more efficient and takes less of a user's time away from important tasks relating to the examination and treatment of patients. Any information contained within the present system and displayed to a user may be dragged into an appropriate window or other location for incorporation into a letter, including portions of the Life Timeline™, any or all medication icons, dashboard elements, and the like.

Other uses or variations on the present system are also contemplated. For example, with respect to the patient self-reporting features of the present invention, wherein a PDA or other mobile device is in use, the device may serve an alarm clock function wherein the patient is required to answer a question regarding the patient's quality or quantity or sleep (or any other question deemed necessary or desirable by a user of the present system) in order to be able to turn off the alarm feature. Further, the PDA or other mobile device may record the time the alarm feature was set as a possible indicator of the time at which the patient went to bed. Further, any of the self-reporting features of the present invention may be implemented using a PDA, any other mobile device, a laptop computer, a desktop computer, or even a phone system wherein a patient dials a phone number associated with a self-reporting function of the present invention and then uses the telephone number pad to enter information or answer questions posed by the present system.

It is contemplated that the present invention may be implemented using any suitable hardware, and that the invention is not limited to any specific hardware discussed above. Any functionality discussed with respect to a PDA, for example, may also be implemented on other portable devices such as a cell phone or MP3 player. Likewise, the present invention is not limited to any specific programming language or file type for storing data. It is contemplated that, upon reading this disclosure, those of skill in the art will be able to implement the principles of the present invention across a variety of suitable hardware and software platforms.

Although the above-described exemplary embodiments of the present invention are directed primarily to the health care professions, and more specifically to the mental health professions, it is contemplated that the principles of the present invention may be adapted to a number of varied occupations, professionals, trades, or art areas. The teleconference feature, embedded reference database, timeline graph feature, note features, dashboard interaction features of the present invention, and the like, may be applied, for example, to the legal field. A legal reference database would take the place of the medical reference database, and the patient history graph of the embodiments described above may be replaced by a client history graph providing at-a-glance information concerning the history of a given case or all cases for a specific client. The automated streamlining features of the present invention could ensure that the legal reference database displayed only information relevant to a client or case being viewed at a specific time (e.g. only those laws applicable in a given state may be displayed, court rules specific to a given court may be displayed while other rules are hidden, or evidentiary rules pertinent to a criminal matter may be displayed while rules specific to civil matters may remain hidden). The wiki or social networking feature of the present invention may also be included, with users able to alter information in the legal reference for themselves alone, or for incorporation into the default reference as it is updated over time. The PVEQ aspects of the present invention could prove to be a valuable resource for an attorney upon the attorney's initial visit with a client. It is contemplated that one of skill in the art would be able to adapt any of the features of the present invention to, for example, a legal setting upon reading this disclosure.

The principles of the present invention could also be applied to the automotive repair industry, with the history graph features of the present invention being adapted to show the entire history of a given automobile, including accidents, prior repairs, recalls, and the like. An automotive reference database could be provided, with a self-streamlining feature designed to hide information not pertinent to a particular vehicle under consideration. The wiki or social networking aspects of the present invention would allow mechanics or automotive professionals to alter the reference database based upon their own experiences, for either their own personal use or for inclusion in the default database as it is updated over time.

It is contemplated that upon reading this disclosure one of skill in the art could reasonably adapt the principles of the present invention to any of these or various other art areas, and such uses of the principles of the present invention are considered to be within the spirit and scope of the present invention. In such other systems, the individual analogous to the ‘patient,’ referred to above with respect to health care-related embodiments of the present invention, may be referred to as the ‘client’ of a user of said system.

The detailed description set forth above is provided to aid those skilled in the art in practicing the present invention. The invention described and claimed herein, however, is not to be limited in scope by the specific embodiments disclosed because these embodiments are intended to be illustrative of several aspects of the invention. Any equivalent embodiments are intended to be within the scope of the present invention. Various modifications of the invention that do not depart from the spirit or scope of the present invention, in addition to those shown and described herein, will become apparent to those skilled in the art from the foregoing description. Such modifications are also intended to fall within the scope of the appended claims.

1. A method for conveying complex or large amounts of data to a user in a readily understandable fashion, the method comprising:
a) providing a computerized graphical user interface for displaying information to a user;
b) providing a reference database containing data pertaining to a field of endeavor engaged in by a user, said reference database being stored on an electronic medium in communication with said computerized graphical user interface;
c) streamlining by an automated process said data contained in said reference database such that at least a portion of said data is identified as being that which is pertinent to a problem being addressed by said user;
d) displaying with said computerized graphical user interface at least a portion of the data identified as being that which is pertinent to a problem being addressed by said user; and
e) displaying to said user with said computerized graphical user interface a graphical timeline illustrating a history of said problem being addressed by said user,
wherein said data and said graphical timeline are displayed concurrently.

2. The method according to claim 1 further comprising the step of displaying at least a portion of said data to said user in the form of a graphical icon.

3. The method according to claim 1 wherein at least a portion of the information pertaining to said history of said problem being addressed by a user is provided by a client of said user in response to an electronic questionnaire answered by said client prior to said user addressing the problem being addressed by said user.

4. The method according to claim 1 wherein said reference database is modifiable by said user.

5. The method according to claim 1 wherein said graphical timeline includes at least one event icon representing an event being displayed along said graphical timeline.

6. The method according to claim 1 wherein said graphical timeline includes a plurality of latitudes, each of said latitudes corresponding to a unique event to be represented along said timeline.

7. The method according to claim 1 further comprising the step of providing a plurality of users, wherein each of said users is able to make modifications to said reference database, said modifications made by any one of said users being visible to at least one other of said users of said system.

8. A method for conveying health care data to a user in a readily understandable fashion, the method comprising:
a) providing a computerized graphical user interface for displaying information to a user;
b) providing a health care reference database, said health care reference database being stored on an electronic medium in communication with said computerized graphical user interface;
c) streamlining by an automated process said data contained in said health care reference database such that at least a portion of said data is identified as being that which is pertinent to a patient of said user;
d) displaying with said computerized graphical user interface at least a portion of the data identified as being that which is pertinent to a patient of said user; and
e) displaying to said user with said computerized graphical user interface a patient history graph displaying a health care history of said problem being addressed by said user,
wherein said health care data and said patient history graph are displayed concurrently.

9. The method according to claim 8 further comprising the step of displaying to a user at least one medication being taken by a patient of said user, said at least one medication being displayed in the form of a graphical icon.

10. The method according to claim 8 wherein at least a portion of the information displayed in said patient history graph is provided by a patient of said user in response to an electronic questionnaire answered by said patient prior to a health care session between said patient and said user.

11. The method according to claim 8 wherein said health care reference database is modifiable by said user.

12. The method according to claim 8 wherein said patient history graph includes at least one event icon representing an event being displayed along said patient history graph.

13. The method according to claim 8 wherein said patient history graph includes a plurality of latitudes, each of said latitudes corresponding to a unique event to be represented along said patient history graph.

14. The method according to claim 8 further comprising the step of providing a plurality of users, wherein each of said users is able to make modifications to said health care reference database, said modifications made by any one of said users being visible to at least one other of said users of said system.

15. A method for conveying complex or large amounts of data to a user in a readily understandable fashion, the method comprising:
providing a computerized user interface for displaying information to a user; and
displaying via said computerized user interface a graphical timeline upon which said data is represented by the use of at least one graphical event icon.

16. The method according to claim 15 wherein the data represented upon said graphical timeline is healthcare-related data.
